(19) United States
(12) Patent Application Publication
(10) Pub. No.: US 2023/0387996 A1
(43) Pub. Date: Nov. 30, 2023

(54) CONSIDERING RADIO CHANNEL DIVERSITY CAPABILITY IN WIRELESS COMMUNICATION NETWORKS

(71) Applicant: Fraunhofer-Gesellschaft zur Foerderung der angewandten Forschung e.V., Munich (DE)

(72) Inventors: Paul Simon Holt LEATHER, Berlin-Schlachtensee (DE); Thomas HAUSTEIN, Berlin (DE)

(21) Appl. No.: 18/448,109

(22) Filed: Aug. 10, 2023

Related U.S. Application Data
(63) Continuation of application No. PCT/EP2022/053392, filed on Feb. 11, 2022.

(30) Foreign Application Priority Data
Feb. 12, 2021 (EP) 21156940.5

(51) Int. Cl. H04B 7/06; H04W 72/51

(52) U.S. Cl. CPC H04B 7/0628; H04W 72/51

(57) ABSTRACT

An apparatus is configured for wirelessly communicating in a wireless communication network. The apparatus comprises a wireless interface arrangement for the wireless communication. The apparatus is configured for wirelessly transmitting, to a receiving apparatus, a diversity signal comprising a diversity information indicating a radio channel diversity (RCD) capability of the apparatus, the RCD capability relating to a capability of the apparatus to perform diversity for the wireless communication.

### CROSS-REFERENCE TO RELATED APPLICATIONS

This application is a continuation of copending International Application No. PCT/EP2022/053392, filed Feb. 11, 2022, which is incorporated herein by reference in its entirety, and additionally claims priority from European Application No. EP 21156940.5, Feb. 12, 2021, which is also incorporated herein by reference in its entirety.

The present application related to the field of wireless communication systems or networks, more specifically to approaches for making wireless communication in such networks more efficient. Embodiments concern improvements in communication adaptation and radio channel considerations. Embodiments further relate to a method to determine the user equipment's spatial data stream separation capability which is referred to as radio channel multiplexing, RCM, capability, and radio channel diversity, RCD, capability. Some embodiments further relate to interference suppression.

### BACKGROUND OF THE INVENTION

In TSG SA #79 and TSG RAN #79 discussion took place on defining mechanisms for optimizing the UE radio capability signalling. RAN sent an LS to TSG SA (cc′ SA WG2) indicating: “ . . . conceptual work should be performed in SA WG2 and RAN WG2 (with potential involvement of other relevant WGs such as RAN WG3 and CT WG1) since the network should store and manage such UE capability IDs”.

Some form of efficient signalling of the UE Radio Capabilities, is to be investigated, which may also rely on an efficient representation of UE capabilities.

Solutions shall take into account a device may have certain features upgraded, e.g. due to a new SW release, or disabling of certain radio capabilities.

The discussion in TSG RAN and SA WG2 previously considered some options for such efficient representation:
1. Using a hash function over the UE capability;
2. Using components or all of IMEI-SV, i.e., TAC+SVN;
3. Using a newly defined identifier.

Other options are possible and can be considered.

The study will also determine whether any identifier used for such efficient representation needs to be globally unique (i.e. standardized), or PLMN-specific or manufacturer-specific.

Starting from that background, there may be a need for improvements in the communication in wireless communication networks.

### SUMMARY

According to an embodiment, an apparatus configured for wirelessly communicating in a wireless communication network may have: a wireless interface arrangement for the wireless communication; wherein the apparatus is configured for wirelessly transmitting, to a receiving apparatus, a diversity signal comprising a diversity information indicating a radio channel diversity (RCD) capability of the apparatus; the RCD capability relating to a capability of the apparatus to perform diversity for the wireless communication.

According to another embodiment, an apparatus configured for wirelessly communicating in a wireless communication network may have: a wireless interface arrangement for the wireless communication; wherein the apparatus is configured for obtaining an RCD information indicating an RCD capability of a communication partner; the RCD capability relating to a capability of the communication partner to perform diversity for the wireless communication; wherein the apparatus is configured for adapting a control of the wireless interface arrangement for a communication with the communication partner based on the RCD capability; and/or to request the communication partner to adapt its wireless communication scheme based on the RCD capability of the first apparatus or on the RCD capability of the second apparatus or on the RCD capability of the first and the second apparatus.

According to another embodiment, an apparatus configured for wirelessly communicating in a wireless communication network may have: a wireless interface arrangement for the wireless communication; wherein the apparatus is configured for wirelessly transmitting, to a receiving apparatus, an interference capability signal comprising a signal interference suppression information indicating a radio interference management, RIM, capability of the apparatus; the RIM capability relating to a capability of the apparatus to suppress interference; wherein the RIM capability indicates a number of spatially distinguishable sources of interference suppressable by the device; or a specific value indicating a number of antennas, or a number representing spatial degrees of freedom, a value indicating a remaining gain to be achieved when transmitting and/or receiving a signal and using the capability.

### BRIEF DESCRIPTION OF THE DRAWINGS

Embodiments of the present invention will be detailed subsequently referring to the appended drawings, in which:

FIG. 1 shows a schematic block diagram of an apparatus according to an embodiment;

FIG. 2 shows a schematic block diagram of a part of a wireless communication network according to an embodiment;

FIG. 3a-b show schematic block diagrams of the wireless communication network of FIG. 2 with varied relative position between an apparatus and a base station according to an embodiment;

FIG. 4 shows a schematic block diagram of a base station according to an embodiment;

FIG. 5 shows a schematic block diagram of a wireless communication network according to an embodiment, having at least one apparatus and at least one base station;

FIG. 6 a schematic flow chart of a method for operating an apparatus according to an embodiment;

FIG. 7 shows a schematic block diagram of a measurement environment according to an embodiment;

FIG. 8 shows a schematic flow chart of a method for evaluating the radio propagation channel between a first node and a second node in a wireless communication network according to an embodiment;

FIG. 9a shows a schematic block diagram of a well-known model of a radio propagation channel;

FIG. 9b shows a schematic block diagram of a known form of the communication model being referred to as propagation channel;

FIG. 9c shows a schematic block diagram of a channel model underlying at least some of the embodiments described herein;

FIGS. 10a-d each schematically show a block diagram of two apparatus configured for performing wireless communication with each other in a SISO, SIMO, MISO and MIMO configuration according to an embodiment;

FIG. 11 shows a schematic block diagram of the apparatus comprising at least one wireless interface arrangement having multiple antenna elements according to an embodiment;

FIG. 12 shows a schematic block diagram of an example antenna arrangement according to an embodiment;

FIG. 13 shows a schematic block diagram of an example of an adaptive antenna array equipped to direct its main beam at and one or more mulls according to an embodiment;

FIG. 14 shows a schematic example diagram as a waterfall plot showing a bit error rate (BER) versus a signal-to-noise-ratio (SNR) for a 64-QAM (quadrature amplitude modulation) with maximum ratio combining in a Rayleigh fading channel to illustrate embodiments;

FIG. 15 shows a schematic block in which for a fixed signal-to-noise ratio of 12 dB measured at the input of a SIMO system according to an embodiment;

FIG. 16 shows a comparison of a performance of various schemes, therein a SISO (1×1), SIMO (1×8, 1×19), MISO (8×1, 19×1) and MIMO (3×3, 1×10) according to an embodiment;

FIG. 17 shows a schematic illustration of a table illustrating a summary of SISO, SIMO, MISO and MIMO according to an embodiment;

FIGS. 18a-f show schematic block diagrams of communication scenarios between mobile devices and a base station in accordance with embodiments;

FIG. 19a shows a schematic block diagram of a wireless communication scenario in accordance with the aspect of exploiting channel diversity according to embodiments;

FIG. 19b shows a schematic block diagram of the wireless communication scenario of FIG. 19a in which an apparatus receives a request signal according to an embodiment;

FIG. 20 shows a schematic flowchart of a method to determine a radio channel diversity capability according to an embodiment;

FIG. 21 shows a schematic block diagram of the wireless communication scenario of FIG. 19a and FIG. 19b wherein a role of a device receiving and transmitting a radio channel diversity capability signal is swapped in accordance with embodiments;

FIG. 22 shows a schematic flowchart of a method for determining a transmit radio channel diversity capability of a node according to an embodiment;

FIG. 23 shows a schematic flowchart of a method for determining a receive radio channel diversity capability of a node according to an embodiment;

FIG. 24 shows a schematic illustration of a relationship between interference suppression, a number of spatial data streams, e.g., in connection with radio channel multiplexing, RCM, and the use of diversity;

FIG. 25 shows a schematic block diagram of a wireless communication scenario comprising a base station and tow UEs to illustrate a concept of interference suppression according to embodiments;

FIG. 26 a schematic block diagram of a wireless network environment is shown that may form at least a part of a wireless network in accordance with embodiments.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to communication in wireless communication networks and to methods, procedures and measurement environments for providing data and information that allow to enhance the communication in wireless communication networks. Although the embodiments described herein may relate to mobile communication networks such as long-term evolution (LTE) or new radio/5G, the scope of the embodiments is not limited hereto. Embodiments relate to communicating, to another node, about own capabilities in view of data stream separation to allow the other node to limit its effort in connection with optimizing communication. In particular, such communication in view of the data stream separation capability may be used to avoid unnecessary optimization efforts at the other node that would go beyond their own capabilities. Such embodiments are not limited to a specific network structure or architecture.

Other embodiments described herein relate to a model which is considered when determining parameters of an apparatus. Such a model considers antennas of a transmitter and of a receiver as being excluded from the radio channel, therefore allowing to separately consider cross-effects between antennas, e.g., between different communication chains, e.g., transmission chains and/or receiving chains. Thereby, a precise determination of the radio channel may be obtained.

A first aspect of the present embodiments aspect relates to indicating to other nodes of a wireless communication scenario or network a radio channel diversity, RCD, capability, i.e., to indicate a capability, which may include not being capable at all, to implement, use or exploit a radio channel diversity in the transmit (TX) and/or receive (RX) direction.

This first aspect is further addressed by procedure for measuring and/or determining such an RCD capability, e.g., in a measurement environment such as a measurement chamber and/or in-field, i.e. during regular operation.

A second aspect of embodiments described herein relates to informing other network nodes about own capabilities in view of data stream separation which may be referred to as radio channel multiplexing (RCM) capability. Such a capability in connection with the described embodiments is based on a priori knowledge of the device's capability. That is, the device capability may be a feature of the device, e.g., of the antenna arrangement such as based on a relative position of antennas inside a housing. This feature may be independent from a channel that is accessed by the device. For this reason, the device capability has to be discriminated from other information such as a Rank Indicator (RI) that may be understood as a channel dependent information. Whilst the RI is based on or derived from a channel assessment made by the user equipment, the capability information according to embodiments is based on the a priori knowledge of the device's capability and may therefore be independent from a radio channel property of a radio channel used by the device and, therefore, independent from a propagation environment of the apparatus. The signal maintenance capability is more a capability of the wireless interface arrangement or the part/portion/section of the wireless interface arrangement being used for communication. Such differences also apply to other known information like the Channel Quality Indicator (CQI) and the Precoding Matrix Indicator (PMI) which are also channel-dependent.

A third aspect of embodiments described herein relates to determining such a separation capability information.

A fourth aspect of embodiments described herein relates to mechanisms that optimize performance through knowledge of device capabilities which may be based on a special model of the radio propagation channel.

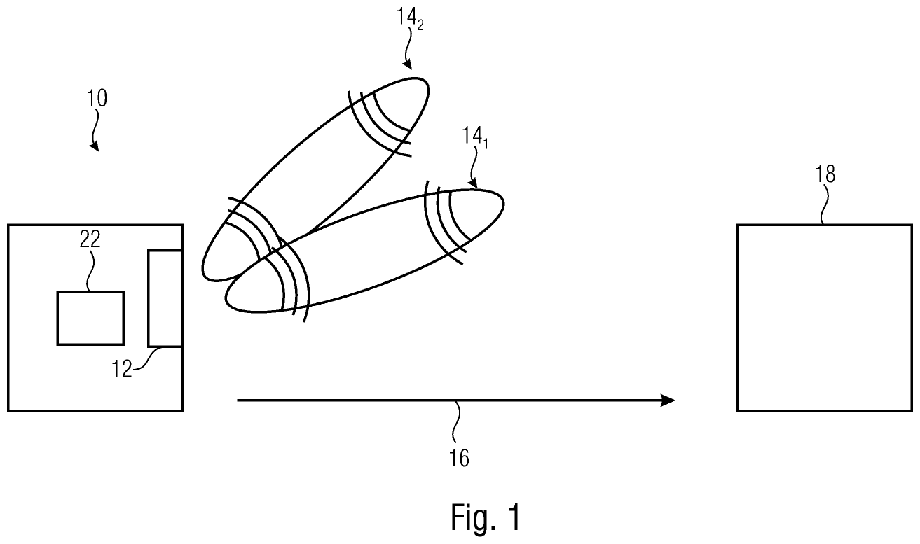

FIG. 1 shows a schematic block diagram of an apparatus 10 being configured for wirelessly communicating in a wireless communication network. For example, the apparatus 10 may be configured for operating in a cell of the wireless communication network. The apparatus may be any device configured for operating in a wireless communication network, for example, an IoT (Internet of Things) device, a user equipment (UE), a vehicle, a base station or the like.

For wirelessly communicating in the wireless communication network, the apparatus 10 may comprise a wireless interface arrangement 12. The wireless interface arrangement 12 may comprise an antenna arrangement. The apparatus may comprise a controller that may be part of the antenna arrangement 12 or may be implemented separately. The wireless interface arrangement 12 may comprise one or more antenna elements. Having a plurality of antenna elements may allow to group such antenna elements to antenna arrays, antenna panels or the like. The wireless interface arrangement 12 may allow the apparatus 10 to maintain one or more data streams 14₁, 14₂ at a time. Each data stream 14₁ and 14₂ may comprise a transmission and/or a reception of data and/or signals. To maintain data stream 14₂ at a time may be understood as simultaneously maintaining the data streams 14₁ and 14₂. This may include but is not limited to simultaneously, at a specific instance of time transmit and/or receive bits of different data streams but is related more general to processing data streams. For example, different data streams may be transmitted and/or received in different frames, subframes, time slots or subcarriers. According to one example, the signal maintenance capability indicating a capability to separate at least one data stream 14₁ and/or 14₂ may be understood as a multiple input multiple output (MIMO) capability. The signal maintenance capability may include to have no capability at all, that is, the apparatus 10 may be configured for maintaining or separating only one single data stream 14₁ or 14₂. According to an embodiment, the apparatus 10 may separate or maintain two or more data streams.

Separating a data stream from another data stream may be performed by the apparatus 10 based on properties or characteristics that different within the data streams 14₁ and 14₂. For example, the data streams 14₁ and 14₂ may differ from each other in at least one of a time domain, a frequency domain, a code domain, a spatial domain, an orbital angular momentum, an angular difference of a lobe or null of a beam pattern or a part thereof. Alternatively or in addition, the data streams 14₁ and 14₂ may differ from each other in the polarization domain.

Embodiments described herein may describe data streams 14₁ and 14₂ as beams of a beam pattern so as to provide for a vivid description of the embodiments. However, any other difference between the data streams or a combination of differences may be implemented. In view of beams, the data streams 14₁ and 14₂ may be understood as spatial data streams that may be separated by the apparatus 10 based on a decorrelation using its MIMO capability. The signal maintenance capability may relate to device capability of the apparatus 10 and may indicate an upper limit for the communication to be maintained or executable with the apparatus 10 within the wireless communication network. For example the apparatus 10 may be configured for generating the capability signal 16 such that the capability information indicates a maximum number of spatial data streams and/or other data streams being utilizable simultaneously with the wireless interface arrangement. For example, the capability information may indicate at least a capability of the apparatus 10 to utilize an indicated number of beams received and/or transmitted with the wireless antenna arrangement 12. For example, the apparatus 10 may be configured for receiving a first spatial data stream with a first beam and for simultaneously or sequentially receiving a second spatial data stream with a second beam. The wireless interface arrangement 12 may be configured for separating the first and second spatial data stream from each other based on the signal maintenance capability. Alternatively or in addition, the first and second spatial data stream may be transmitted with a first beam, a second beam respectively. Based on the signal maintenance capability, the data streams being transmitted with the first and the second beam may be separated from each other. As described, the first spatial data stream (beam) and the second spatial data stream (beam) may be received or transmitted simultaneously.

The data stream may, in view of the apparatus, a desired signal or useful signal but may also be an interfering signal, disturbing signal or unwanted signal. For example, the data stream representing or containing a useful signal may be separated with respect to another useful data stream used or maintained by the apparatus. Alternatively or in addition, a data stream may be separated from background noise, an unwanted signal or other interference. As a further alternative which may be implemented also in addition, an interfering data stream not maintained by the apparatus may nevertheless be separated, e.g., from other data streams or background noise or interference, e.g., when the apparatus may decode it. Such an unwanted data stream may be used for further processing, e.g., to allow subtracting its content from an overall signal being received to thereby allow to separate another data stream, thereby suppressing the interfering influence.

In other words, separating a data stream may relate to separating at least one spatial stream from the “desired” transmitter. It may also refer to
a) A data stream transmitted from the transmitter intended to be received by the receiver and/or
b) An interference signal transmitted from an interfering transmitter intended to be received by a communication partner of the interferer or intended to jam/disturb the radio environment within a certain range/direction.

In other words, in examples, a data stream can contain intended and/or unintended information or signals for the recipient.

A purpose of a) may be to multiplex multiple data streams to be transmitted from a transmitting node to a receiving node and the capability to separate these from another stream from signals of the same base station/node/apparatus or from interference coming from another source and from noise. A purpose of b) may be to either suppress an interfering signal and/or successfully detect them in order to subtract them in sequential stages of successive interference cancelation.

A spatial data stream may thus relate to a useful signal or data stream but may also, especially in view of interference, relate to a data stream transmitted to the apparatus to be received with the apparatus or from the apparatus intended to be received by a receiver and/or an interference signal transmitted from an interfering transmitter intended to be received by a communication partner of the interfering transmitter or intended to jam/disturb the radio environment within a certain range/direction.

The apparatus 10 may comprise a memory 22 having stored thereon the capability information. The capability information may be any kind of encoded or uncoded information.

This device capability may be independent from a propagation environment of the apparatus. In other words, the apparatus 10 may be configured to obtain a specific number of data streams at a same time, for example, in an ideal environment. Although some of those data streams may not be maintained in a real environment or scenario, this will not change the signal maintenance capability in view of a path being blocked to the base station, for example, in case a car travels between a UE and a base station. Nevertheless, the maintenance capability may be specific for an operating mode or orientation of the apparatus 10. For example, the apparatus 10 may have knowledge about a user being positioned with respect to the apparatus 10. E.g., the apparatus 10 may determine that a head of a user is near its display such that the apparatus 10 decides not to transmit beams towards the head. Such a scenario may change the present or current maintenance capability but not as an effect of the radio channel but as an effect of the operating mode. As another example, the apparatus 10 may be configured for maintaining different numbers of data streams along different directions starting from the apparatus. That is, when a communication partner, e.g., a base station, is arranged on varying sides or orientations with respect to the apparatus 10, the maintenance capability may vary based on different or varying capabilities of the apparatus 10 along different sides.

The apparatus 10 is configured for wirelessly transmitting a capability signal 16 to a receiving apparatus 18. The apparatus 10 may transmit the capability signal 16 repeatedly, during an association or re-association with a base station, when setting a peer-to-peer communication and/or repeatedly, e.g., in regular or irregular time intervals or upon having determined a variation in its maintenance capability. Such an association may occur, for example, when powering up the apparatus, when having performed a handover, during an association in a new cell or when setting up a network. The apparatus 10 may alternatively transmit the capability signal 16 responsive to receiving a corresponding request signal. For example, the base station may transmit once, regularly or in irregular intervals, a respective request.

The capability signal 16 may indicate the signal maintenance capability such that the receiving apparatus 18 may obtain knowledge about the maintenance capability of the apparatus 10. This allows the receiving apparatus 18 and/or an apparatus to which the maintenance capability information is forwarded, to consider the capabilities of the apparatus 10 when adapting communication. For example, the receiving apparatus 18 may try to improve data transmission by adapting a beam and/or by generating further beams towards the apparatus 10. Based on a knowledge about the upper limit of the signal maintenance capability, the receiving apparatus 18 may avoid trying unnecessary or non-effective attempts to increase or improve communication.

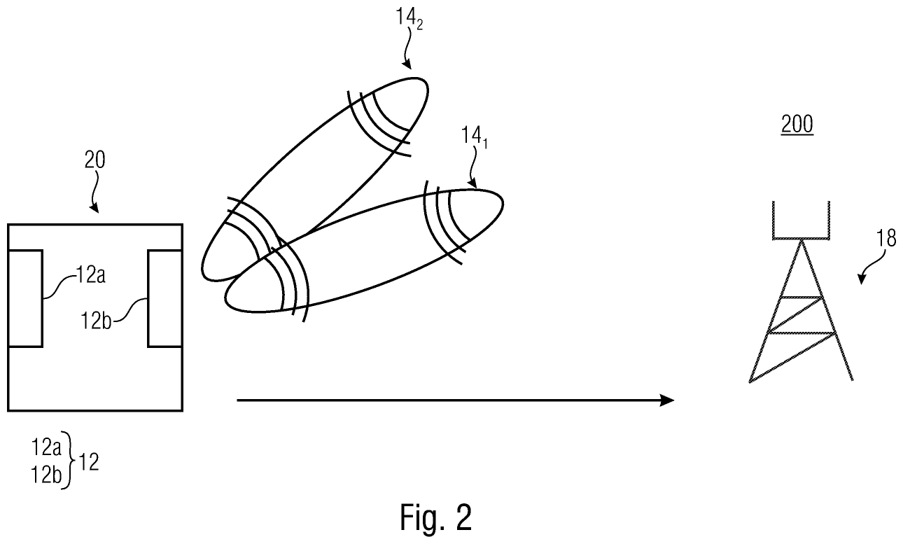

FIG. 2 shows a schematic block diagram of a wireless communication network 200, a cell thereof respectively. For example, the receiving apparatus 18 may be a base station operating the wireless communication network cell. An apparatus 20 may associate or re-associate with the base station 18. Alternatively, the apparatus 20 may already be associated with the base station 18. The apparatus 20 may have at least a first and a second antenna arrangement 12a and 12b being parts of the wireless interface arrangement 12. Each antenna arrangement may be implemented so as to allow for beamforming. The apparatus 20 may be configured for individually using the antenna arrangement 12a or the antenna arrangement 12b for wireless communication, i.e., either the antenna arrangement 12a or 12b. Alternatively, the apparatus 20 may be configured for combinatorially using the antenna arrangements 12₁ and 12₂ for wireless communication. Although the apparatus 20 is described as comprising two antenna arrangements, each antenna arrangement being implemented so as to allow for beamforming, the apparatus 20 may comprise a different, in particular higher number of antenna arrangements, for example, 3, 4, 5, 10, 20 or more.

The wireless interface arrangement 12 may be configured for associating each separable data stream with a communication channel of the apparatus. For example, different applications being executed by the apparatus may each maintain one or more communication channels which are processed simultaneously by a physical layer (PHY) of the apparatus.

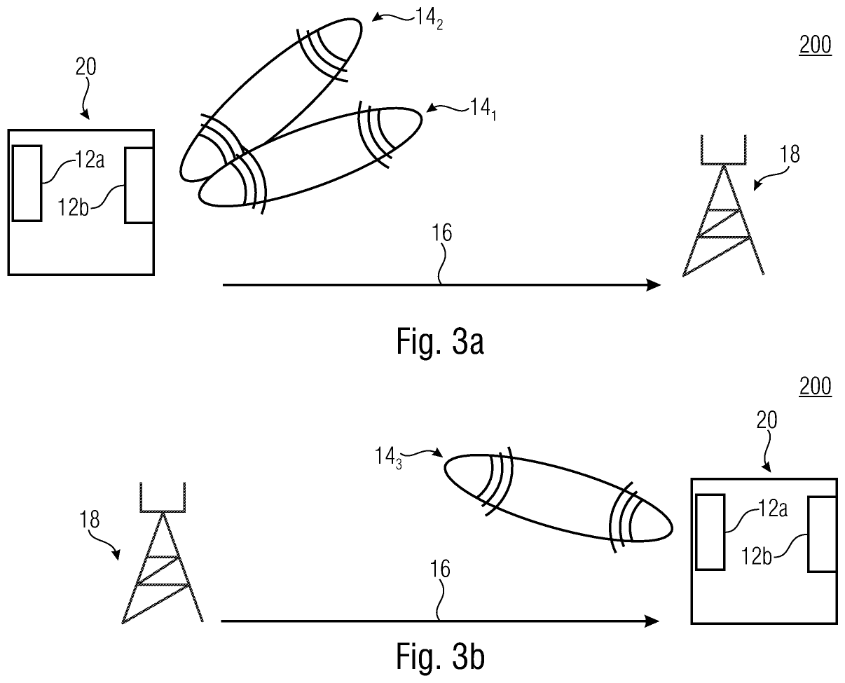

FIG. 3a and FIG. 3b show schematic block diagrams of the wireless communication network 200 of FIG. 2. A relative position between apparatus 20 and the base station 18 has changed between the illustration of FIG. 3a and FIG. 3b. In FIG. 3a, the antenna arrangement 12b is used by the apparatus 20 so as to communicate with the base station 18. The antenna arrangement 12b may be implemented to maintain a first number of data streams, e.g., two, and may be used for communication with the base station 18 as it faces the base station 18.

In FIG. 3b, the apparatus 20 uses antenna arrangement 12a to communicate with the base station 18. The antenna arrangement 12a may be configured for maintaining a different second number of data streams, e.g., the data stream 14₃. The apparatus may determine that the signal maintenance capability is changed from the maintenance capability of FIG. 3a to a varied signal maintenance capability. The apparatus may report the varied signal maintenance capability to the base station 18, for example, by transmitting again a capability signal 16. Alternatively or in addition to a variation in a position that may lead to a change in an antenna arrangement used by the apparatus 20 for communication, the apparatus 20 may be configured for determining that the signal maintenance capability has changed based on one or more of a change of an operation mode of the apparatus, an orientation of the apparatus, and/or a position of at least a part of a user relative to the apparatus. For example, in different operating modes, the apparatus 20 may consume different levels of power allowing a different number of data streams to be utilized. For example in different orientations of the apparatus, the apparatus may use different numbers of data streams and/or different antenna arrangements. The apparatus 20 may be configured for reporting the varied signal maintenance capability periodically, responsive to having determined the change or responsive to a request received with the wireless interface arrangement 12.

The capability information transmitted to the receiving apparatus 18 may be specific for the apparatus 20, 10 respectively. This may include the capability information to be specific for the device class, i.e., for a class of devices to which the device belongs. For example, a same device series, all devices being built equally, may have stored thereon a respective identifier or capability information that indicates the device so as to belong to the device class. Alternatively, the capability information may indicate the device individually. Based thereon, the receiving apparatus 18 may determine or derive the capability of the device. That is, the apparatus 10 and/or 20 may indicate its capability so as to be interpreted by the receiving apparatus without further knowledge. Alternatively or in addition, the device may indicate itself, e.g., using an identifier or may identify a class to which it belongs. This may allow the receiving apparatus 18 to interpret or derive the capability information when having further knowledge about the device or device class. The capability information to be transmitted with the capability signal 16 may relate to an uplink capability and/or a downlink capability of the apparatus. A combined capability information may indicate both, the uplink and the downlink capability. Different capabilities for uplink and downlink may be transmitted as different information in a same signal or as different signals.

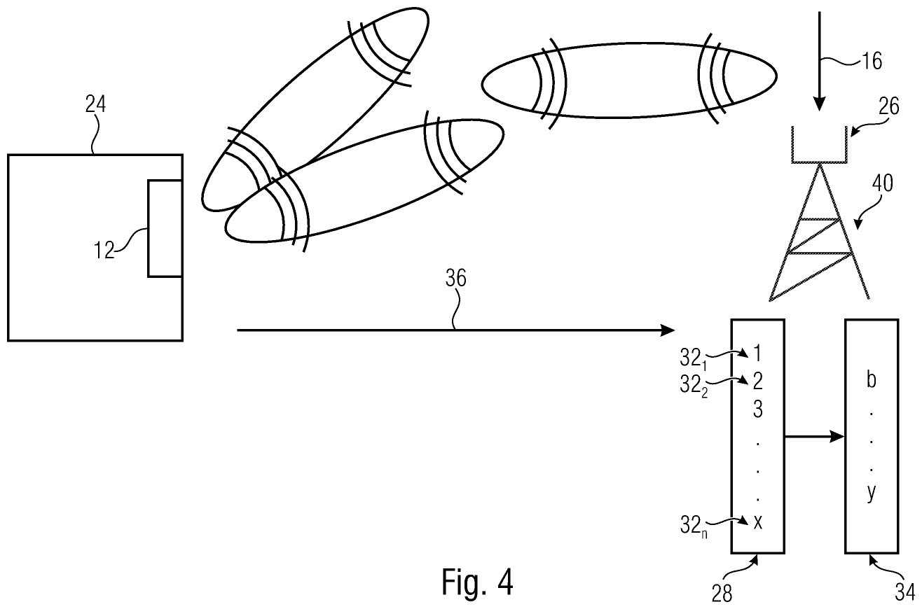

FIG. 4 shows a schematic block diagram of a base station 40 according to an embodiment. The base station 40 is configured for operating at least a cell of a wireless communication network, for example, the wireless communication network 200. By way of example, one or more apparatuses 24 may be associated with the base station 40. The apparatus 24 may be implemented, for example, as apparatus 10 and/or 20. The base station 40 comprises an antenna arrangement 26 configured for transmitting and/or receiving to or from the apparatus 24 a plurality of data streams. By way of example, a plurality of transmission and/or reception beams may be formed towards the apparatus 24, wherein the data stream 14 is not limited to such a spatial data stream, as described. The base station is configured for receiving the capability signal 16 comprising the capability information indicating a signal maintenance capability of the apparatus 24. The capability signal 16 may be transmitted by the apparatus 24 but may, alternatively, be received by a central network node, for example, in the backbone.

The base station 40 may use the antenna arrangement 26 to form in total a set 28 of data streams 31₁ to 32ₓ with x being any number larger than 1, for example, at least 5, at least 10, at least 20 or at least 50. Within the capability of the base station 40, one or more data streams 32ᵢ with i=1, . . . , x, may be used by the base station 40. Upon having knowledge about the signal maintenance capability of the apparatus 24, the base station 40 may limit the set 28 by selecting a subset 34 of the set 28, for example, having a lower number of data streams 32. This may also be understood as the base station 40 may decide, responsive to the capability information, to limit efforts in view of optimizing communication with the apparatus 24. For example, a number of beams or spatial data streams may be limited. Alternatively or in addition, a modulation coding scheme (MCS), a spatial spreading, a selection of time slots, a selection of code or the like may be limited according to the capability of the apparatus 24. Each of those different properties may be understood as a separate or different data stream. Further influencing parameters may be, for example, a data rate, a latency or the like to be adapted.

The apparatus 24 may provide for a feedback information 36. This feedback information 36 may be received as a respective wireless data signal by the base station 40. The base station 40 may be configured for adaptively adapting the set 34 responsive to the feedback information 36. The feedback information 36 may indicate a data transmission quality of a data transmission between the base station 40 and the apparatus 24. For example, a signal-to-noise ratio (SNR) or signal plus interference-to-noise ratio (SINR) or a channel quality indicator (001) or the like or a combination thereof may be transmitted. For example, the base station 40 may determine that the transmission quality in the uplink and/or downlink is below a desired transmission quality. That is, the base station 40 may determine that the channel is of poor quality. The base station may be configured for adapting the set 34 so as to increase the transmission quality of the data transmission within the signal maintenance capability of the apparatus. That is, according to an embodiment, the base station 40 is configured to limit its efforts to increase the transmission quality to the signal maintenance capability of the apparatus 24. For example, the capability information may indicate at least a capability of the apparatus 24 to utilize an indicated number of beams received or transmitted with its wireless antenna arrangement 12. The base station 40 may be configured to select the set 34 of data streams such that a number of data streams of the set 34 is at most the number indicated in the capability signal 16.

As described, the base station 40 may be configured for providing or supplying the network with an association procedure with the apparatus 24 when it associates or re-associates with the cell. The base station 40 may be configured to query the capability information 16 during such an association procedure.

This may allow to prevent the apparatus 24 to transmit the capability signal 16 in case it associates with a cell that is not making use of such information. Alternatively or in addition to querying for the capability information, the base station may be configured for transmitting a request signal indicating a request to report the capability information prior or after the association or re-association procedure. Such a request signal may be transmitted to the apparatus 24 itself or to a central data base of the wireless network, thereby querying if the apparatus 24 is already known within the central node.

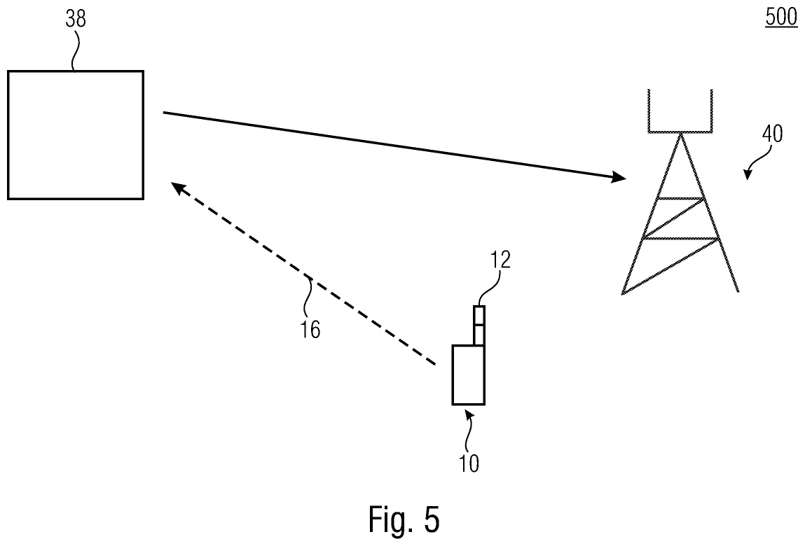

FIG. 5 shows a schematic block diagram of a wireless communication network 500 according to an embodiment, the wireless communication network 500 may comprise at least one apparatus 10, 20 and/or 24. The wireless communication network may further comprise at least one base station 18 and/or 40. The wireless communication network 500 may optionally comprise a database 38 accessible for the at least one base station 40. The data base 38 may comprise the signal maintenance capability of the apparatus 10. The capability signal 16 may directly or indirectly be transmitted to the database 38. Based thereon, the database 38 may contain a measure for at least a first data signal and a second data signal or data stream maintainable by the apparatus 10. Such a measure may be at least one of an error vector magnitude (EVM), a signal-to-interference-plus-noise ratio (SINR), a bit error rate (BER), a block error rate (BNER) and/or a combination thereof. This may allow for precise information about the capability of the apparatus 10 to be present at the base station 40. The wireless communication network 500 may be configured for repeatedly updating the database 38, for example, by updating the capabilities associated with a device class, for example, by a manufacturer and/or upon receiving the capability signal 16 directly or indirectly from the apparatus 10. According to an embodiment, a method for operating an apparatus for wirelessly communicating in a wireless communication network, wherein the apparatus comprises a wireless interface arrangement having a signal maintenance capability to separate at least one data stream, comprises wirelessly transmitting, to a receiving apparatus, a capability signal comprising a capability information indicating the signal maintenance capability. This method may be used, for example, for operating the apparatus 10 and/or 20.

According to an embodiment, a method for operating a base station for operating at least a cell of a wireless communication network, the cell having an apparatus being associated with the base station, the base station configured for transmitting and/or receiving a plurality of data streams with an antenna arrangement, comprises a step in which a capability signal comprising a capability information indicating a signal maintenance capability of the apparatus is received. In a further step, a set of data streams is used for communicating with the apparatus. In a further step, the set of data streams is selected based on the capability information. A sequence or order of the steps may be implemented differently.

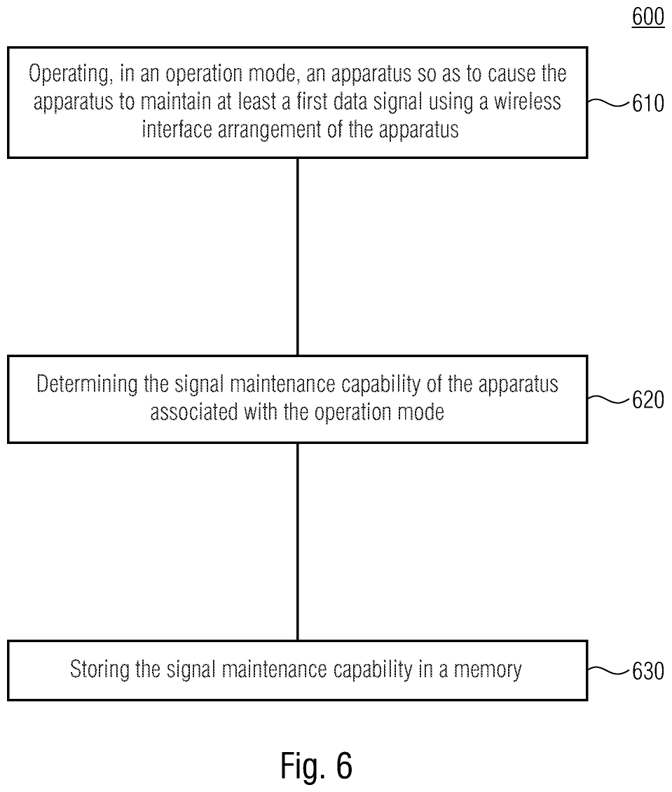

For obtaining information about a signal maintenance capability to be distributed in the network as described in connection with FIG. 1 to FIG. 5, embodiments provide for a method 600 being illustrated in FIG. 6. A step 610 comprises operating, in an operation mode, an apparatus so as to cause the apparatus to maintain at least a first data signal using a wireless interface arrangement of the apparatus. That is, in step 610, the apparatus may be tested in view of a number of data streams or data signals to be maintained in the operation mode. In a step 620, the signal maintenance capability of the apparatus within the operation mode is determined. In a step 630, the signal maintenance capability is stored in a memory. Optionally, the operating mode may be stored together with the maintenance capability in the memory. Such storing may be performed implicitly, for example, when the apparatus 10 only has a single operating mode to be determined or examined.

The method may, optionally, comprise a step of changing the operation mode of the apparatus with respect to the at least one data signal. The method may comprise determining the signal maintenance capability of the apparatus associated with the changed operation mode. The method may further comprise storing the changed signal maintenance capability in the associated changed operation mode in the memory. That is, it may be of advantage to store the signal maintenance capability together with the operation mode in case the apparatus is able to operate under different operation modes that are associated with different data stream capabilities.

Changing the operation mode may be related to at least one of change of a correlation between antenna elements of the apparatus, e.g., by activating or deactivating one or more antenna elements, antenna panels or antenna arrays. Alternatively or in addition, changing the operation mode may be related to a change in a channel propagation to or from the antenna elements of the apparatus, e.g., when a user is located at least partly along a direction along which a beam may be formed or is intended to be formed. Alternatively or in addition, the change of the operation mode may be related to a change of an orientation of the apparatus with respect to a base station or a link antenna of a measurement equipment used for testing the apparatus, similarly as described in connection with FIGS. 3a and 3b, whilst the receiving apparatus 18 may be implemented by one or more link antennas. Such a link antenna may simulate for at least parts of a functionality of a base station. Alternatively or in addition, a change in the operation mode may be related to a change in a number of data channels maintained between the measurement set up and the apparatus.

The method 600 as well as the described extension, for which each step may be performed independently, may be performed so as to rely on a channel model in which an antenna correlation between antennas used for a signal transmission using the signal maintenance capability and/or an antenna correlation between antennas used for a signal reception using the signal maintenance capability is considered. As an antenna it is understood an arrangement of one or more antenna elements suited for combinatorially transmitting or receiving a signal. That is, in an antenna array, an antenna element is the smallest radiating part of the array. The antenna correlation of antennas may be of higher interest when compared to antenna correlation between elements of a same antenna.

Operating the apparatus in the operation mode may be performed such that the apparatus maintains the at least a first data stream in a specific reference condition for a channel. For example, the apparatus may be tested in a measurement environment, e.g., in a measurement chamber such as an anechoic chamber. The apparatus may be illuminated from one or more sides so as to simulate the specific reference condition. Illuminating may be done from all sides at a time, from different sides at different times, e.g., corresponding to the antennas examined at this time; and/or from a constant direction whilst moving or rotating the apparatus. The method may further comprise determining the antenna correlation at least between a first antenna and a second antenna of the wireless interface arrangement.

That is, the antenna correlation that at least indicates the impairment between antenna may be determined under the reference condition. That is, the signal maintenance capability may be determined in view of the reference condition of the channel. The antenna correlation may be determined so as to comprise an information about the antenna correlation of antenna in different antenna arrangements of the wireless interface arrangement.

The method may alternatively or in addition performed such that the signal maintenance capability is determined for at least a first use case and a second use case of the apparatus; the first use case and the second use case differing in view of antenna used by the apparatus in the operating mode. For example, the different use cases may refer to different antenna and/or different antenna arrangements of the apparatus for maintaining the data stream. E.g., based on a rotation of the apparatus and/or user relative to the base station, the apparatus may maintain the same data stream but may use a different antenna panel or antenna arrangement or sets thereof for communication therefore changing the use case. Alternatively or in addition, a use may change based on other situations. For example, a user may change its relative position to the apparatus, e.g., holding the apparatus to a different ear, taking the apparatus from a table and put it next to a head or the like. The apparatus may detect such changes and may change its utilization of the wireless interface arrangement, e.g., to avoid forming a beam to or through the user's head. The signal maintenance capability may be stored together with the use case. That is, the apparatus may react on determined changes change in a channel propagation to or from the antennas of the apparatus.

The apparatus may report its signal maintenance capability together with an associated use case and/or may report a change in the signal maintenance capability during operation, e.g., when having switched from one operation mode or use case to another.

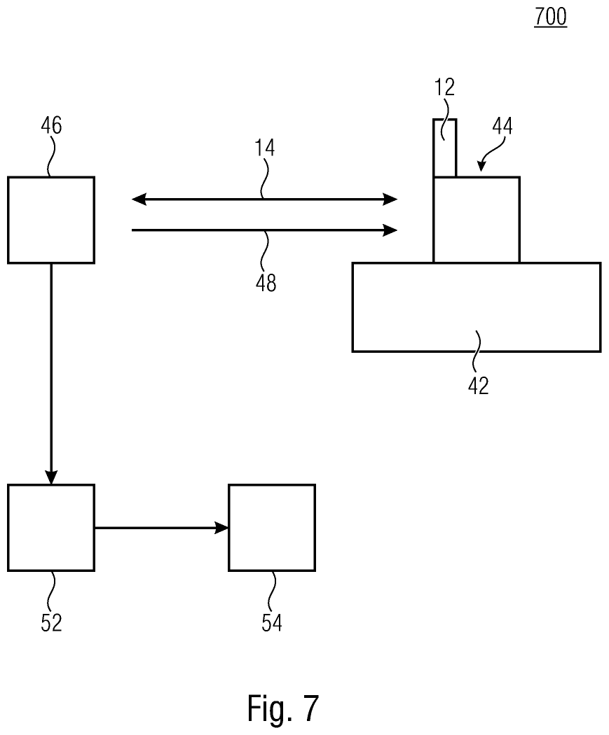

FIG. 7 shows a schematic block diagram of a measurement environment 700 according to an embodiment. The measurement environment 700 comprises a holder 42 configured for holding an apparatus 44, e.g., the apparatus 10 and/or 20 or a device of a similar type. The measurement environment 700 comprises a control unit 46 configured for controlling the apparatus 44 so as to operate the apparatus under an operation mode. The control unit 46 may cause the measurement environment 700 to transmit one or more control signals 48 in a wired or wireless manner to the apparatus 44 so as to control its operation mode. In the controlled operation mode, the apparatus 44 may maintain at least one data stream 14 using the wireless interface arrangement of the apparatus 44.

The measurement environment 700 may comprise a determining unit 52 configured for determining the signal maintenance capability of the apparatus 44 associated with the operation mode. The measurement environment 700 may comprise a memory 54 configured for storing the signal maintenance capability, optionally, together with the associated operation mode.

A method in accordance with an embodiment, for example, implemented or executed at least partly by use of the measurement environment 700, comprises connecting an apparatus to be tested to a measurement environment or placing the apparatus in the measurement environment. For example, the apparatus may be placed on the holder 42, e.g., a chuck, a jig, a table, a floor or the like. The method comprises transmitting a number of multiplexed signals to the apparatus, for example, using a link antenna. The method comprises demultiplexing the multiplexed signals with the apparatus, e.g., the apparatus 44. A result of the demultiplexing may be transmitted back to the measurement environment. The method comprises comparing the demultiplexed signals with the multiplexed signals so as to obtain a comparison result. That is, it may be determined if the apparatus 44 has successfully demultiplexed the multiplexed signals. Based thereon, the signal maintenance capability of the apparatus may be determined based on the comparison result. That is, it may be tested if the apparatus is able to demultiplex the number of multiplexed signals. The test may be done iteratively such that a number of multiplexed signals to be transmitted to the apparatus may increase or decrease in different iterations. This may be implemented so as to find a maximum number of multiplexed signals that may be demultiplexed with the apparatus.

The comparison result may thus be determined so as to indicate a number of signals successfully demultiplexed. According to an embodiment, demultiplexed signals may be provided to the apparatus and it may be determined, if the apparatus is able to successfully multiplex the signals. For comparing multiplexed signals with the demultiplexed signals, a use of a signal processing technique may be used, for example, a correlation function or an autocorrelation function.

According to an embodiment, the method for determining the signal maintenance capability may optionally contain one or more of the following steps: connecting the apparatus or placing the apparatus in the measurement environment, providing a number of signals to the apparatus, causing the apparatus to multiplex the number of signals and to transmit the number of multiplexed signals to the measurement environment, demultiplexing the multiplexed signals with the measurement environment and comparing the demultiplexed signals with the multiplexed signals so as to obtain a comparison result. Further, the signal maintenance capability may be determined based on the comparison result. Thereby, the comparison result may be determined so as to indicate a number of signals successfully multiplexed. Comparing the demultiplexed signals with the multiplexed signals may also be implemented by use of a signal processing technique.

The embodiments described relate to a UE that reports certain capabilities and to how the knowledge of same may benefit both, the UE and the network. As mobile broadband communication networks continue to evolve from one generation to the next, for example, from 4G Long Term Evolution (LTE) to 5G New Radio (NR) and beyond, not only do the number of mobile devices supported by these networks increase but also the number of device types. In other words, these networks are needed to support an ever-increasing variety of user equipment (UE) and provide the needed Quality of Service according to each UE's category or capability. Within standardization groups such as 3GPP, the discussion of UE capability is an ongoing topic as shown, for example, in 3GPP TR 23.743 V0.2.0 (2018-08).

At the base station, multi-antenna systems and their associated techniques enable radio access networks to provide higher data rates, increased capacity and improved reliability in a more spectrally efficient and energy conscious manner. For 5G NR, such developments are relevant to frequency bands in the range of frequencies known as frequency range 1-FR1 (450 MHz-6,000 MHz) and frequency range 2-FR2 (24,250 MHz-52,600 MHz). These techniques are, however, pertinent to any particular operating frequency, regardless of the current definition of FR1 and FR2, to future releases and to evolutions and systems of the future that go beyond 5G.

In “Effect of Antenna Mutual Coupling on MIMO Channel Estimation and Capacity” (Xia Liu and Marek E. Bialkowski, School of ITEE, The University of Queensland, Brisbane, QLD 4072, Australia) it is stated that “The mathematical analysis and simulation results have shown that when the antenna element spacing at either transmitter or receiver is within 0.2 and 0.4, the mutual coupling decreases the spatial correlation level and undermines the estimation accuracy of the MIMO channel.” The design and implementation of the antennas used in an UE will affect its ability to accurately assess channel characteristics. This may also affect the UE's to maximize its performance in higher ranking MIMO channels.

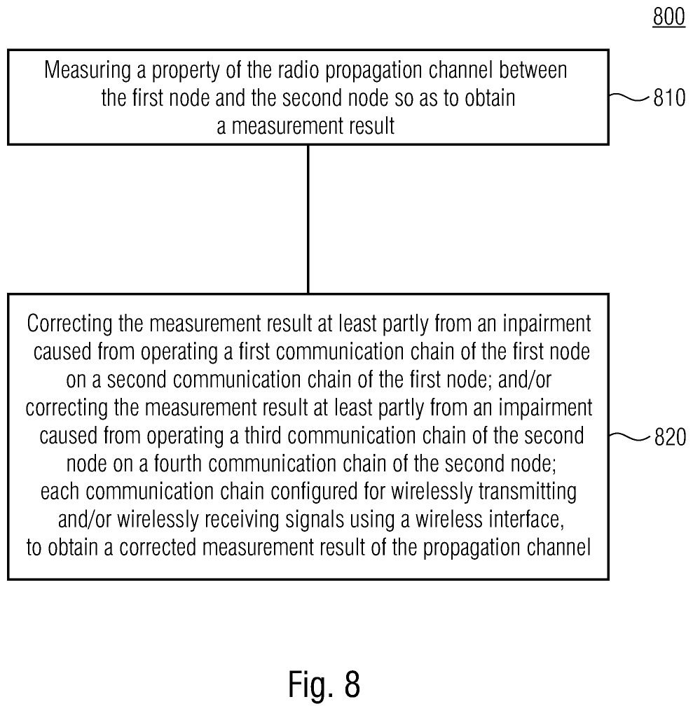

Further embodiments provide for a method for evaluating a radio propagation channel between a first node and a second node in a wireless communication network. An example for this embodiment is illustrated in FIG. 8 showing a schematic flow chart of a method 800 for evaluating the radio propagation channel between a first node and a second node in a wireless communication network. A step 810 comprises measuring a property of the radio propagation channel between the first node and the second node so as to obtain a measurement result. A step 820 comprises correcting the measurement result at least partly from interference or impairment caused from operating a first communication chain of the first node on a second communication chain of the first node and/or correcting the measurement result at least partly from impairment caused from operating a third communication chain of the second node on a fourth communication chain of the second node. Each communication chain is configured for wirelessly transmitting and/or wirelessly receiving signals using a wireless interface. By correcting the measurement result, a corrected measurement result of the propagation channel is obtained.

Embodiments described herein relate, at least in parts, to interference, e.g., in connection with step 820. In the context of radio signal transmission and reception, the term interference may be used to describe an unwanted signal that affects the transmission/reception of a wanted signal. With respect to the wanted signal, and in some instances, the unwanted signal can be considered to be a form of noise. In connection with the embodiments described, such kind of interference may also be understood as impairment, i.e., an effect on one signal on another.

An apparatus configured for wirelessly transmitting and/or receiving signals may utilize a communication chain for transmitting or receiving a signal. A communication chain is used as a term describing a transmission chain and/or a reception chain. Such a chain may comprise amplifiers, digital-to-analogue and/or analogue-to-digital converters, antenna elements, signals processing steps and the like.

An apparatus may comprise one or more communication chains. For example, a plurality or even a multitude of transmission chains and/or a plurality or even a multitude of receiving chains may be implemented, in particular in connection with MIMO devices. Therefore, the presented method also applies to an apparatus such as apparatus 10, 20, 24 or 44.

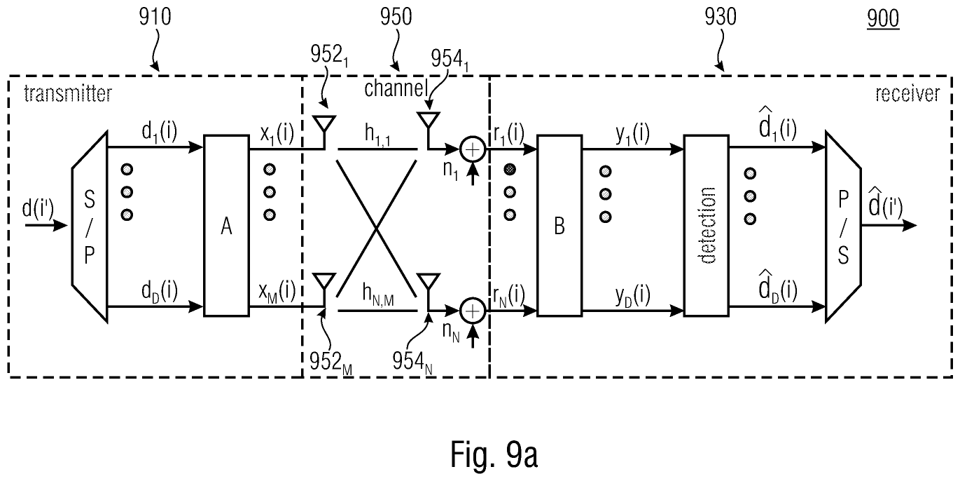

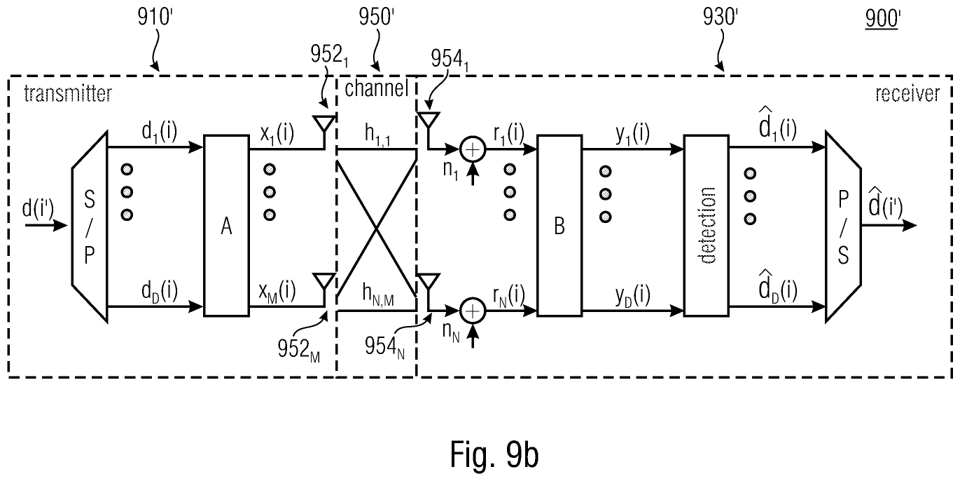

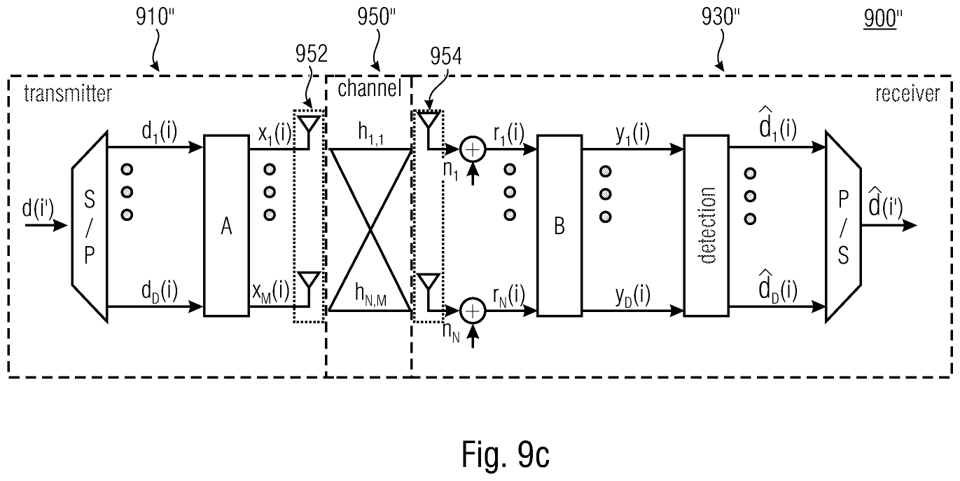

The inventors have found that it is of particular interest and advantageous to consider the transmission chains including the antenna elements used thereof as part of the device and not as part of the radio propagation channel. For example, FIG. 9a shows a schematic block diagram of a well-known model of a radio propagation channel 900 comprising a section 910 relating to the transmitter, comprising a section 930 relating to the receiver and comprising a section 950 relating to the channel. Antenna elements 9521 to 952M used by the transmitter for different transmission chains d₁(i) to d_{D}(i) are considered as being part of the channel 950. So are antenna elements 954₁ to 954_{N} of the receiver. The well-known model of FIG. 9a shows a configuration in which the channel 950 comprises both propagation and antenna effects. In this sense, the channel is better referred to as “radio channel”.

In FIG. 9b, a less known form of the model is shown, in which the channel comprises propagation effects only. In this sense, the channel may be referred to as “propagation channel”. The antenna elements 953 and 954 are considered to be part of the transmitter 910′, the receiver 930′ respectively.

In contrast hereto, FIG. 9c shows a schematic block diagram of the channel model underlying at least some of the embodiments described herein. It is based on the finding that an antenna correlation between the antenna elements 952 (transmit antennas) and/or a cross-correlation between the antenna elements 954 (receive antennas) may be considered. This allows correcting the measurement result of method 800 so as to obtain the property of the radio propagation channel 950″ independently from antenna properties of the first node and the second node, i.e., the transmitter and the receiver. Such impairment information being obtained may be stored in a memory. The impairment information stored in the memory may be read from the memory at a later time and a wireless communication may be set up in a wireless communication channel using the impairment information to determine the property of the wireless communication channel independent from the impairment. That is, in particular in connection with the capability information, apparatus that comprise a plurality of antenna elements or antenna arrangements in a wireless interface arrangement may face antenna correlation in the transmit antennas and/or the receive antennas. This antenna correlation may at least in parts be influenced by a construction form or design of the apparatus such that different designs or locations or distances between antenna elements may have different antenna correlations. This may lead to different data stream capabilities in different operating modes and/or orientations or the like even if different apparatus having different designs may comprise a same number of antennas. Embodiments relate to identifying such influence and to correcting measurement results based on this finding.

Correcting the measurement result may be performed such that the corrected measurement result of the propagation channel may exclude antennas of the first node and the second node from a propagation channel model modelling the propagation channel. Alternatively or in addition, the method may comprise using the corrected channel propagation information for adjusting a wireless communication. Adjusting the wireless communication may comprise at least one of a prompt or immediate adjustment of a running or ongoing or existing communication, an adjustment at the beginning of a next burst, slot, sub-frame, frame or hyper-frame of the wireless communication, adjustments of a change of frequency, beam, antenna panel, antenna polarization, power, modulation and/or coding, radio access technology (RAT), a change of the network, a change of orientation of an apparatus, a change of a direction of communication and a use case. Alternatively or in addition, the adjustment may be queued, i.e., it may be performed at a later stage. Combinations are included.

According to an embodiment, the method 800 may comprise requesting the adjustment at a network entity and processing the request. The method comprises not performing the adjustment in case of a negative feedback. That is, the adjustment may be announced and in case an apparatus replies a negative feedback, the adjustment may be skipped or waived.

The method 800 may alternatively or in addition comprise storing an adjustment and/or an adjustment request for subsequent analysis and/or performance optimization of the apparatus and/or the apparatus.

Based on this consideration, embodiments provide for an apparatus, e.g., apparatus 10,20, 24 and/or 44, comprising a memory having stored thereon impairment information indicating an impairment caused from operating a first communication chain of the apparatus on a second communication chain of the apparatus, e.g., impairment between antenna elements 952 and/or impairment between antenna elements 954. Such an apparatus may optionally be configured for transmitting the impairment information to a further information such that it may consider the properties of the apparatus. In connection herewith, embodiments provide for an apparatus, e.g., a receiving apparatus such as apparatus 18 or the base station 40, configured for controlling a wireless communication to a further apparatus based on impairment information indicating an impairment caused from operating a first communication chain of the further apparatus on a second communication chain of the further apparatus. That is, the apparatus may consider impairment that will be caused at the other apparatus when using specific settings of the wireless communication. For example, knowledge may be used that a specific combination of beams, frequencies, codes or the like leads to an increased impairment when compared to other combinations such that the apparatus may choose combinations with lower impairment over other combinations.

In other words, referring again to FIG. 9c, the boxes 952 and 954 refer to the antenna correlation of antennas. Box 952 relates to TX antennas, e.g., at the base station. Antennas 954 relate to RX antennas, e.g., at the UE. The transmitter, e.g., the base station, may be provided with antenna correlation via manufacturers' declarations. A TX correlation (of the base station antennas), e.g., a one-time process since the correlation is unlikely to ordinarily change. The RX correlation (of the UE antennas) may be provided in a dynamic process as each new UE is connected in a call and the UEs are invariably of different type/design/manufacture/user configuration. The receiver, e.g., the UE, may provide updated antenna correlation information according to how the UE is held/positioned. The correlation information may be used by the transmitter (base station) to improve the estimation of the propagation channel, to improve the quality of the channel pre-coding, to achieve the needed channel quality faster, to reduce adaption time and/or to respond to changes more quickly.

The embodiments described in connection with the capability information being transmitted to a receiving mode apply also to base stations. For example, in a given area/location, the base station is provided up to, e.g., rank 4 for single user MIMO or, e.g., rank 8 for multiuser MIMO (4× rank 2) and at an adjacent location, it may keep the full SU-MIMO (Single-user MIMO) rank. This in in contrast to usual cell centre high rank and cell edge low rank as it may provide consistency of user experience in space over an entire coverage region in multi-cell environment. A result of beam forming optimization may be verified. It may be measured by in-situ measurement, for example by using UEs in the field that report the observed rank and SU-MIMO rank consistency in space/location/coverage area. The UE's directionality may be considered and averaged out. Low rank capable UEs may provide wrong results about the SU-MIMO rank in space area. The reporting can be dynamic depending on how the UE is held, e.g., certain positions might create a low rank resolution for the UE. The UE may report its maximum rank capability, for example, when registering to the network or regularly from time to time. With this information, the network knows what to expect from the UE in a given environment. Embodiments introduce a new metric describing a ratio of best to lowest layer performance (MSC level) or best/worst eigenvalue. As a measure, for example, of multiplexing robustness in a given environment, a superposition of propagation environment and base station transmit strategy and resulting UE capability may be obtained. At a certain given rank and balance of multi-layer transmission, the UE capability in such environment/probing can be tested.

The results may be UE specific. A UE may have a different number of stream to downlink and uplink, e.g., 4 Rx, 2 Tx and the base station may possibly be unable to estimate the UE antenna/receiver capability from observation of signals transmitted by the UE to the base station. Therefore, embodiments provide for a feedback on the spatial beam separation capability in both direction under known spatial decorrelation by propagation. Further, a measurement environment and base station beam forming is described.

Furthermore, if some spatial relationship between Tx and Rx antenna patterns is known (measure of how well the Tx and Rx patterns correspond), one can be used to optimize the other. For example, the analogue beam forming network from 4 Rx antennas to 4 Rx ports may be used to create 2 Tx beams using all 4 antennas or some of them.

Embodiments provide for a test that allows conformance test of multi-stream performance (single user MIMO) to allow for Nx max MCS/modulation, e.g., 256QAM or different, e.g., 1024QAM, for FR1 and 64QAM up to 256QAM for FR2. Embodiments provide further for a measurement environment equipped to provide multi-stream with full rank >2 or alike with spatial stream separation of X dB, i.e., a test if the UE can do, e.g., full MUX or impairment suppression. A test rank of 1, 2, 3, 4, . . . , etc. may be implemented. Embodiments do not focus on a wireless cable with long-term stable phase and channel estimation. Instead, embodiments target spatial separability of streams as a property of the test environment. This is implemented by using specific rank co-polarized, cross-polarized and hybrid mixtures of polarization.

As a further aspect, over-the-air (OTA) tests may be used to obtain an OTA performance that may at least partly depend on a perceived rank and signal decorrelation. A UE may report its observed maximum rank, its capability information. This may be a superposition of the channel and the capabilities of the UEs. Using the antenna test function (ATF), embodiments introduce an ATF-prime after MIMO equalization, meaning the power and the SINR of de-correlated streams with or without power correction may be performed, indicating an MUX level.

Further, embodiments allow to exploit that changing the metric allows extraction of the resulting inter-stream impairment representing stream coupling. This can be used by measurement equipment of gNB to further decouple multiplexed streams.

The UE spatial capability may set an upper limit for the exploitable performance enhancing measurements.

Embodiments may allow to reduce the amount of signalling, power consumption and impairment.

Embodiments allow to classify the UE in (spatial) capability classes where the capability might be direction dependent. For example, a certificate might state that the UE is rank 4 capable in 30% of sphere, rank 3 in 50% and rank 2 in 80%, etc. Any other arbitrary number of ranks and/or sizes of the sphere are possible.

The principle on which the embodiments rely can be extended to carrier aggregation including dual connectivity, e.g., LTE+NR/EN-DC, performance measurement for concurrent DL-CA, UL-CA and UL-DL-CA (DL=downlink, UL=uplink, CA=carrier aggregation). Here, the scheduler and network synchronization may play a role, too. This may result in a category/score/KPI (key performance indicator) based on testing criteria.

Information used by other entities in the network for the overall link and network optimization is provided.

Information about the UE or UE capability categorization is provided to the network and is updated if an effective capability depending on, e.g., network configuration or channel, such that the individual links and the network performance can be optimized.

For Mobile Network Operators (MNOs), if the UEs have confirmed spatial capabilities, then the MNO can use them to test and optimize network performance by optimizing base station antenna, matching the channel propagation characteristic of a particular site or deployment.

The second aspect relates to reporting the spatial stream separation capabilities of a device:
a) Device capabilities can change according to use cases (hand, head and body effects), orientation, frequency of operation [carrier aggregation {intra-band contiguous/non-contiguous, inter-band}], selection of antenna panel, direction of beam(s).
b) Includes UE, IoT device and base station equipment.
c) Devices which are receptive to the capability information should be able to use the information to adjust/adapt/improve/optimize the generation/creation of spatial streams according to defined criteria—not each time to “increase”, sometimes to “decrease” (for example when limiting factors are known/detected/anticipated).

The third aspect relates to measurement method and defines
a) how the spatial separation capability is determined
b) what technique is used to create and radiate spatially separated streams that maintain the needed characteristics throughout transmission
c) what methods can be used to control/check/measure the spatial separation of the streams delivered to the device under test

The fourth aspect relates to mechanisms that optimize performance through knowledge of device capabilities

a) Traditionally, the characteristics of both the transmit and receive antennas are “lumped” together with the characteristics of the “propagation channel” to form a single entity called the “radio channel”. By assessing the characteristics of both the transmit and receive antennas (optionally together with their radio frequency front-end circuitry used for either both transmission or reception [not to ignore various forms of duplex operation including full duplex]), the propagation channel per se can be treated as a single entity. In essence, the “radio channel” is partitioned into: a transmit chain that includes the transmit antennas; the propagation channel; and a receive chain that includes the receive antennas. The correlation between two or more transmit chains including their antennas can be determined (see 2 above)—so too can that of the two or more receive chains including their antennas. Such information is now known independently from the radio channel thus allowing better estimation of the prevailing propagation channel.

Embodiments provide for an apparatus (e.g. a base station, a terminal (including a UE), an IoT device, a test equipment, a test environment) comprising a combination of transmit antennas and transmission chains and a combination of receive antennas and reception chains wherein each combination has certain characteristics and those characteristics can be assessed in order to determine a capability of either or both of the combinations. In other words: a) the transmission capability of the apparatus and the reception capability of the apparatus need not necessarily be identical; b) it might be possible/useful to determine the capability of only the transmission combination, the reception combination or both combinations together. While the assessment of the apparatus is typically made using test and measurement equipment (a measurement environment) and normally before deployment in a network, further assessment methods should not be excluded examples of which include self-assessment (through built-in test equipment (BITE) functionality), network-assisted assessment in which one or more base stations and/or one or more terminals are configured/orchestrated to perform such an assessment.

b) The Tx branch correlation and the Rx branch correlation information can be used to adjust/adapt/improve/optimize the characteristics of the spatially separated streams.

This may be performed in a time domain, a frequency domain, a code domain, a spatial domain, an orbital angular momentum, an angular difference of a lobe or null or a part thereof and a polarization domain

The used measure may be at least one the measure is at least one of: an error vector magnitude (EVM); a signal-to-interference-plus-noise ratio (SINR); a bit error rate (BER); a block error rate (BLER); and a combination thereof.

Furthermore, adjustments can be made according to frequency division multiplexing (FDM) criteria which can include carrier aggregation wherein certain band combinations become a capability per se as too do the bands which are used as primary and/or secondary carriers. Yet a further example is the use in multi-network or multiple radio access technologies (multi-RAT) in dual-connectivity (DC) [also between different RATs] or multi-connectivity [also between different RATSs].

Adjustments can be made automatically in response to certain criteria (thresholds/events/network signalling/built-in performance self-measurement/a sensed change of usage/low-battery level/temperature detection/interference indication).

Adjustments can be made immediately.

Adjustments can be scheduled to the occur at the beginning of the next burst/slot/sub-frame/frame.

Adjustments can be initiated with a change of frequency/beam/antenna panel/antenna polarization/power/modulation or coding or both/RAT/network/orientation/direction/use case.

Adjustments can be queued/sequenced/delayed/scheduled.

Adjustment requests can be processed (i.e., accepted or rejected or referred to a higher entity for further processing).

Adjustments and adjustment requests can be stored for subsequent analysis and/or performance optimization of the apparatus and/or the network.

Adjustments and adjustment requests can be stored in the apparatus, the network, a test environment.

In the following, additional embodiments and aspects, especially in connection with the aspect relating to the signal multiplexing capability, RCM respectively, will be described which can be used individually or in combination with any of the features and functionalities and details described herein. In particular and as described in more detail herein, the embodiments may be combined, without limitation, with aspects relating to radio channel diversity, RCD, capability and/or interference suppression.
1. An apparatus configured for wirelessly communicating in a wireless communication network, the apparatus comprising:
   a wireless interface arrangement having a signal maintenance capability to separate at least one data stream;
   wherein the apparatus is configured for wirelessly transmitting, to a receiving apparatus, a capability signal comprising a capability information indicating the signal maintenance capability.
2. The apparatus of aspect 1, wherein the signal maintenance capability relates to a MIMO capability of the apparatus comprising a decorrelation to separate at least one spatial data stream.
3. The apparatus of aspect 1 or 2, wherein the apparatus is configured for separating at least two data streams based on the signal maintenance capability.
4. The apparatus of aspect 3, wherein a first data stream and a second data stream of the at least two data streams differ from each other in at least one of a time domain, a frequency domain, a code domain, a spatial domain, an orbital angular momentum, an angular difference of a lobe or null or a part thereof and a polarization domain.
5. The apparatus of one of previous aspects, wherein the signal maintenance capability relates to a device capability forming an upper limit for the communication within the wireless communication network independent from a propagation environment of the apparatus.
6. The apparatus of one of previous aspects, wherein the wireless interface arrangement comprises at least a first and a second antenna arrangement, wherein the apparatus is configured individually or combinatorially using the first antenna arrangement and the second antenna arrangement.
7. The apparatus of one of previous aspects, wherein the apparatus is configured for generating the capability signal such that the capability information indicates a maximum number of spatial data streams being utilizable simultaneously with the wireless interface arrangement.
8. The apparatus of one of the previous aspects, wherein the capability information indicates at least a capability of the apparatus to utilize an indicated number of beams received and/or transmitted with the wireless antenna arrangement.
9. The apparatus of one of the previous aspects, wherein the wireless interface arrangement is configured for receiving a first spatial data stream with a first beam; and for receiving a second spatial data stream with a second beam, wherein the wireless interface arrangement is configured for separating the first spatial data stream from the second spatial data stream based on the signal maintenance capability.
10. The apparatus of one of the previous aspects, wherein the wireless interface arrangement is configured for transmitting a first spatial data stream with a first beam; and for transmitting a second spatial data stream with a second beam, wherein the wireless interface arrangement is configured for separating the first spatial data stream from the second spatial data stream based on the signal maintenance capability.
11. The apparatus of aspect 9 or 10, wherein the apparatus is configured for simultaneously receiving or transmitting the first spatial data stream and the second spatial data stream.
12. The apparatus of one of previous aspects, wherein the wireless interface arrangement is configured for associating each separable spatial data stream with a communication channel of the apparatus.
13. The apparatus of one of the previous aspects, wherein the apparatus is configured for transmitting the capability signal during an association procedure or a re-association procedure provided by the wireless communication network; or for transmitting the capability signal responsive to receiving a corresponding request signal.
14. The apparatus of one of the previous aspects, wherein the apparatus is configured for determining that the signal maintenance capability is changed to a varied signal maintenance capability and to report the varied signal maintenance capability to the receiving apparatus.
15. The apparatus of aspect 14, wherein the apparatus is configured for determining that the signal maintenance capability has changed based on at least one of:
   an operation mode of the apparatus;
   an orientation of the apparatus;
   a position of at least a part of a user relative to the apparatus; and
   a change in an antenna arrangement of the wireless interface arrangement for communication.
16. The apparatus of aspect 14 or 15, wherein the apparatus is configured for reporting the varied signal maintenance capability periodically; responsive to having determined the change or responsive to a request received with the wireless interface arrangement.
17. The apparatus of one of previous aspects, comprising a data memory having stored thereon the capability information.
18. The apparatus of one of previous aspects, wherein the capability information is device specific for the apparatus; or device class specific for a class of devices to which the device belongs.
19. The apparatus of one of previous aspects, wherein the capability information relates to an uplink and/or downlink capability of the apparatus.
20. The apparatus of one of previous aspects, being a UE, an Internet-of-Things device or a base station.
21. A base station configured for operating at least a cell of a wireless communication network, the cell having an apparatus being associated with the base station, the base station comprising:
   an antenna arrangement configured for transmitting to and/or receiving from the apparatus a plurality of data streams;
   wherein the base station is configured for receiving a capability signal comprising a capability information indicating a signal maintenance capability of the apparatus;
   wherein the base station is configured for using a set of data streams from the plurality of data streams for communicating with the apparatus; and
   wherein the base station is configured for selecting the set of data streams based on the capability information.
22. The base station of aspect 21, wherein the base station is configured for adaptively adapting the set of data streams responsive to a feedback information received from the apparatus, the feedback information indicating a data transmission quality of a data transmission between the base station and the apparatus;
   wherein the base station is configured for determining that a transmission quality is below a desired to transmission quality and for adapting the set of data streams so as to increase the transmission quality of the data transmission within the signal maintenance capability of the apparatus.
23. The base station of aspect 21 or 22, wherein the capability information indicates at least a capability of the apparatus to utilize an indicated number of beams received or transmitted with a wireless antenna arrangement of the apparatus, wherein the base station is configured to select the set of data streams such that a number of data streams of the set of data streams is at most the indicated number.
24. The base station of one of aspects 21 to 23, wherein the base station is configured for providing an association procedure or re-association procedure for associating the apparatus with the wireless communication network cell; wherein the base station is configured for providing the association procedure so as to query the capability information; and/or wherein the base station is configured for transmitting a request signal indicating a request to report the capability information.
25. The base station of aspect 24, wherein the base station is configured to transmit the request signal to the apparatus or to a central data base of the wireless network.
26. Wireless communication network comprising:
   at least one apparatus according to one of aspects 1 to 20; and
   at least one base station according to one of aspects 21 to 25.
27. The wireless communication network of aspect 26, comprising a database accessible for the at least one base station and comprising the signal maintenance capability of the apparatus.
28. The wireless communication network of aspect 27, wherein the database contains a measure for at least a first data stream and a second data stream maintainable by the apparatus.
29. The wireless communication network of aspect 28, wherein the measure is at least one of:
   an error vector magnitude (EVM);
   a signal-to-interference-plus-noise ratio (SINR);
   a bit error rate (BER);
   a block error rate (BLER); and
   a combination thereof.
30. The wireless communication network of one of aspects 27 to 29, configured for repeatedly updating the database.
31. Method for operating an apparatus for wirelessly communicating in a wireless communication network, the apparatus comprising a wireless interface arrangement having a signal maintenance capability to separate at least one data stream; the method comprising:
   wirelessly transmitting, to a receiving apparatus, a capability signal comprising a capability information indicating the signal maintenance capability.
32. Method for operating a base station for operating at least a cell of a wireless communication network, the cell having an apparatus being associated with the base station, the base station configured for transmitting and/or receiving a plurality of data streams with an antenna arrangement; the method comprising:
   receiving a capability signal comprising a capability information indicating a signal maintenance capability of the an apparatus;
   using a set of data streams for communicating with the apparatus; and
   selecting the set of data streams based on the capability information.
33. A computer readable digital storage medium having stored thereon a computer program having a program code for performing, when running on a computer, a method according to aspect 31 or 32.
34. Method for determining a signal maintenance capability of an apparatus, the method comprising:
   operating, in an operation mode, an apparatus so as to cause the apparatus to maintain at least a first data stream using a wireless interface arrangement of the apparatus;
   determining the signal maintenance capability of the apparatus associated with the operation mode; and
   storing the signal maintenance capability in a memory.
35. The method of aspect 34, further comprising:
   changing the operation mode of the apparatus with respect to the at least one data stream;
   determining the signal maintenance capability of the apparatus associated with the changed operation mode; and
   storing the changed signal maintenance capability and the associated changed operation mode in the memory.
36. The method of aspect 35, wherein changing the operation mode is related to at least one of:
   a change of a correlation between antenna elements of the apparatus;
   a change in a channel propagation to or from the antenna elements of the apparatus;
   a change of an orientation of the apparatus with respect to a link antenna of a measurement equipment used for testing the apparatus;
   a change in a number of data channels maintained between the measurement setup and the apparatus.
37. The method of aspect 35 or 36, wherein the method is performed so as to rely on a channel model in which an antenna correlation between antenna elements used for a signal transmission using the signal maintenance capability and/or an antenna correlation between antenna elements used for a signal reception using the signal maintenance capability is considered.
38. The method of aspect 37, wherein operating the apparatus in the operation mode is performed such that the apparatus maintains the at least a first data stream in a specific reference condition for a channel; wherein the method further comprises:
   determining the antenna correlation at least between a first antenna and a second antenna of the wireless interface arrangement;
   such that the signal maintenance capability is determined in view of the reference condition of the channel.
39. The method of aspect 37 or 38, wherein the signal maintenance capability is determined for at least a first use case and a second use case of the apparatus; the first use case and the second use case differing in view of antennas used by the apparatus in the operating mode;
   wherein the signal maintenance capability is stored together with the use case.
40. The method of one of aspects 34 to 39, wherein the antenna correlation is determined so as to comprise an information about the antenna correlation of antennas in different antenna arrangements of the wireless interface arrangement.
41. The method of one of aspects 34 to 40, comprising:
   connecting the apparatus to or placing the apparatus in the measurement environment;
   transmitting a number of multiplexed signals to the apparatus;
   demultiplexing the multiplexed signals with the apparatus;
   comparing the demultiplexed signals with the multiplexed signals so as to obtain a comparison result;
   determining the signal maintenance capability based on the comparison result.
42. The method of aspect 41, wherein the comparison result is determined so as to indicate a number of signals successfully demultiplexed.
43. The method of aspect 41 or 42, wherein comparing the multiplexed signals with the demultiplexed signals comprises a use of a signal processing technique.
44. The method of one of aspects 34 to 43, comprising:
   connecting the apparatus to or placing the apparatus in the measurement environment;
   providing a number of signals to the apparatus;
   causing the apparatus to multiplex the number of signals and to transmit the multiplexed signals to the measurement environment;
   demultiplexing the multiplexed signals with the measurement environment;
   comparing the demultiplexed signals with the multiplexed signals so as to obtain a comparison result;
   determining the signal maintenance capability based on the comparison result.
45. The method of aspect 44, wherein the comparison result is determined so as to indicate a number of signals successfully multiplexed.
46. The method of aspect 44 or 45, wherein comparing the demultiplexed signals with the multiplexed signals comprises a use of a signal processing technique.
47. A computer readable digital storage medium having stored thereon a computer program having a program code for performing, when running on a computer, a method according to one of aspects 34 to 46.
48. A measurement environment comprising:
   a holder configured for holding an apparatus;
   a control unit configured for controlling the apparatus to operate the apparatus, under an operation mode, in which the apparatus maintains at least a first data stream using a wireless interface arrangement of the apparatus;
   a determining unit configured for determining the signal maintenance capability of the apparatus associated with the operation mode; and
   a memory wherein the measurement environment is configured for storing the signal maintenance capability in the memory.
49. A method for evaluating a radio propagation channel between a first node and a second node in a wireless communication network, the method comprising:
   measuring a property of the radio propagation channel between the first node and the second node so as to obtain a measurement result;
   correcting the measurement result at least partly from an impairment caused from operating a first communication chain of the first node on a second communication chain of the first node; and/or correcting the measurement result at least partly from an impairment caused from operating a third communication chain of the second node on a fourth communication chain of the second node; each communication chain configured for wirelessly transmitting and/or wirelessly receiving signals using a wireless interface, to obtain a corrected measurement result of the propagation channel.
50. The method according to aspect 49, wherein each communication chain is configured as a transmission chain or a receiving chain.
51. The method according to aspect 49 or 50, wherein correcting the measurement result is executed so as to obtain the property of the radio propagation channel independently from antenna properties of the first node and the second node.
52. The method according to one of aspects 49 to 51, further comprising:
   storing an impairment information indicating the determined impairment in a memory; and
   reading the impairment information and setting up a wireless communication in a wireless communication channel using the impairment information to determine the property of the wireless communication channel independent from the impairment.
53. The method according to one of aspects 49 to 52, wherein correcting the measurement result is performed such that the corrected measurement result of the propagation channel excludes antennas of the first node and of the second node from a propagation channel model modelling the propagation channel.
54. The method according to one of aspects 49 to 53, comprising:
   using the corrected channel propagation information for adjusting a wireless communication.
55. The method according to aspect 54, wherein adjusting the wireless communication comprises at least one of:
   a prompt adjustment of running communications;
   an adjustment at the beginning of the next burst, slot, sub-frame, frame or hyper-frame of the wireless communication;
   adjustments of a change of frequency, beam, antenna panel, antenna polarization, power, modulation and/or coding, RAT, a change of the network, a change of orientation of an apparatus, a change of a direction of communication and a use case; and
   a queued adjustment.
56. The method according to aspect 54 or 55, further comprising:
   requesting the adjustment at a network entity and processing the request and for not performing the adjustment in case of a negative feedback.
57. The method according to one of aspects 54 to 56, further comprising:
   storing an adjustment and/or an adjustment request for subsequent analysis and/or performance optimization of the apparatus and/or the network.
58. A computer readable digital storage medium having stored thereon a computer program having a program code for performing, when running on a computer, a method according to one of aspects 49 to 57.
59. An apparatus comprising a memory having stored therein impairment information indicating an impairment caused from operating a first communication chain of the apparatus on a second communication chain of the apparatus.
60. The apparatus of aspect 59, wherein the apparatus is configured for transmitting the impairment information to a further apparatus.
61. An apparatus configured for controlling a wireless communication to a further apparatus based on impairment information indicating an impairment caused from operating a first communication chain of the further apparatus on a second communication chain of the further apparatus.

Whilst some embodiments described herein relate to support a use of one or multiple data streams by indicating a capability to separate at least one data stream, such information providing for a basis of support at the communication partner that knowns about the capability to separate data streams, the present invention is not limited hereto. In the following the first aspect will be described that may also benefit from additional antennas. This aspect may be combined with the already described second to fourth aspect, without any limitation. Whilst such additional antennas may serve as a basis for using MIMO techniques to allow a use of one or more data streams as described, such antennas may, in accordance with embodiments be used for diversity purposes to increase reliability of transmission and, likewise, reception of wireless signals.

In wireless communication channels, multiple received replicas of the transmitted signal can sometimes combine destructively such that the signal is said to “fade”. Indeed, the probability of severe fades is significant and without the means of mitigating such fading effects, significant power margins might be needed to ensure reliability.

Fortunately, however, fades tend to be localized in both space and frequency. For example, a change in the location of the transmitter or receiver (in the order of a carrier wavelength) or in the frequency (in the order of the inverse of the propagation delay spread) leads to approximately independent fading processes. Fading is thus said to be “selective” and from this, the concept of diversity is borne: instead of depending on the success of a transmission entirely on a single fading realization, use multiple realizations to reduce the probability of transmission failure. Diversification is an almost universal action taken when uncertainty prevails—it finds application not only in communications but also in fields as contrasting as economics and biology.

Over time the term “diversity”, when used in the context of communications, has acquired different meanings to the point of becoming overused. For example, it is used to describe: variations of the underlying channel in time, frequency, space, etcetera; performance metrics related to the error probability in which nuances allow more than one such metric to be defined; and transmission and/or reception techniques designed to improve such metrics.

Primitive forms of diversity, which relied on the operator's manual selection of a receiver with the best quality, were first introduced over a century ago with automatic selection of the strongest signal following as early as 1930. Instead of simply selecting the strongest signal, methods were then investigated to combine signals using receive antenna combining. One of the most well-known schemes—still used to this day—was first proposed in 1954: maximum ratio combining (MRC)). In addition to receive antenna combining, early analogue microwave links that did not use coding, employed multiple transmission of the same information using different carrier frequencies. Not surprisingly however, such bandwidth greedy approaches soon became unattractive and paved the way for the use of antennas as the advantageous diversity approach. Recognizing this point, receive antenna combining has since been almost universally adopted for use at base station sites. It took industry much longer to investigate the use of multiple antennas in mobile devices. Even though successful trials were reported in the 1970s with the advanced mobile phone system (AMPS), it was not until the early 1990s that dual-antennas were used in the Japanese PDC system.

Uplink receive diversity can be readily adopted at the base station where antennas can normally be separated by several wavelengths, either or both horizontally and vertically. It is not quite so obvious how to achieve diversity in the downlink using only multiple transmit antennas. In an environment where the signals can be described to fade with Rayleigh-like statistical properties—commonly mistermed as “Rayleigh fading”—the simultaneous transmission of each symbol from every antenna is equivalent to using a single transmit antenna. Suboptimal schemes have however been formulated in which the spatial selectivity is effectively converted across the transmit antennas into time or frequency selectivity. Such methods rely on multiple copies of each symbol being transmitted from the various antennas wherein the symbol is subjected to either a phase shift or a time delay. When viewed from the standpoint of the receiver, the effective channel now exhibits enhanced time or frequency selectivity. Coding and interleaving techniques now allow a diversity advantage to be had.

Improved transmit diversity techniques started to emerge in the 1990s, an example being orthogonal space-time block codes (OSTBC) which later developed into space-time codes in general. Although OSTBCs were first developed for single-antenna receivers, they are also used in multiple-input multiple-output (MIMO) communication—those in which both transmitter and receiver have a multiplicity of antennas. This allows for additional diversity, and thus reliability, but no increases in the number of information symbols per MIMO symbol.

Modern wireless communication systems not limited to include 4G-LTE, 5G-NR, WiMax, and WiFi make use of multiple antennas at both ends of the communication link. This is done in order to allow for a variety of multi-antenna transmission and reception schemes which provide either: a) spatial diversity for channel hardening and increased resilience against small scale fading (as introduced above); or b) spatial multiplexing capability where multiple data streams can be simultaneously transmitted from a multiple(N)-antenna transmitter to a multiple(M)-antenna receiver (to be explained next). The resulting multi-transmit antenna to multi-receive antenna radio channel is often denoted as a multiple input multiple output channel (MIMO) with matrix dimensions (M×N). The associated spatial degree of freedom is min(M,N) and the remaining spatial diversity gain of such an M×N arrangement of antennas is at most (meaning maximum) abs(M−N)−min(M,N). To give an example, we assume one node to be equipped with 4 antennas while the other node is equipped with 8 antennas. The maximum spatial degree of freedom is min(8,4)=4, which means that a maximum of 4 data streams can be transmitted simultaneously reusing the same time and frequency resources. The extra 4 antennas can be used at the node in transmit and/or receive mode as diversity enhancement, helping to improve the condition number of the overall MIMO channel, while the rank is maintained at 4. The condition number is defined as the ratio of the highest and lowest Eigenvalue of radio channel when applying singular value decomposition (SVD).

Since the radio channel corresponds to statistical components in case or rich multipath propagation, the effective rank of the MIMO channel may vary in time and in particular under mobility and transmit and/or receive antenna correlations or even if the channel between location A and location B is rank deficient by default due to specific geometries e.g. in keyhole channels.

Assuming a rich multi-path environment without structural deficiencies, the stability of the MIMO rank can be improved when additional diversity antennas are used at one or both sides. For instance, a MIMO system with M=N=4 could be configured to operate on dual streams only while using 2 more antennas than at the transmitter and the receiver for diversity to enhance and stabilize the MIMO rank. Such a mechanism is often referred to as channel hardening which describes the fact that fading events will occur less likely, therefore eliminating the small scale fading uncertainty of the radio channel and, in particular, under mobility conditions.

In real world scenarios, not all diversity antennas may contribute to the same extent to improve and harden the MIMO channel. Reasons might include antenna pattern correlation which results in limited statistically independent (uncorrelated) channel realizations (when adding one more antennas) OR some antennas may contribute significantly less to the overall MIMO radio channel e.g. by receiving 10 dB or less receive signal strength than the average of the others. Such signal strength differences in the MIMO matrix coefficients, matrix columns or rows, reduces significantly the effectiveness of additional diversity antennas.

The effective diversity gain of a MIMO system can be evaluated by measuring the uncoded bit error rate (BER) over a number of sufficiently Rayleigh like channel realizations in rich multipath. In M=N antenna constellations the BER slope goes down by 10 every extra 10 dB of SNR. While an M×N MIMO system with one extra antenna at the transmit or receive side and appropriate MIMO scheme will experience a BER curve with 2 decade per 10 dB SNR increase etc.

Therefore, when assessing the performance of a multi-antenna system the contributed multiplexing capability and the contributed diversity capability of each node and the two nodes together is to be measured in detail and if possible independently.

Therefore, the inventors propose to introduce a measurement scheme (test) to evaluate the spatial multiplexing (data stream separability) capability and the complementing spatial diversity capability (channel hardening) which in combination with appropriate spatial signal processing at the transmitter and/or receiver enable either increased spectral efficiency (high degree of spatial multiplexing) and/or higher reliability in MIMO rank stability and MIMO rank improvement by better channel conditioning (condition number of the MIMO channel is reduced). The extreme and best MIMO condition number is 1, when all Eigenvalues are identical and feeding into and feeding out of the channel allows for the same rate on all multiplexed streams, therefore achieving the highest MIMO capacity possible at high SNR.

In millimeter wave communications in 3GPP frequency range 2 (FR2), the multiple antennas are often used for beamforming using antenna element arrangements in large arrays, e.g. 8×8 antenna elements in a planar structure. Such antenna arrays in principle allow for multi-stream (data stream multiplexing) as well when an appropriate communication partner with multi-stream capability is available. When using antenna arrays with a larger number of antenna elements on each side of the channel e.g. N=64 (8×8) and M=16 (2×8), the strong correlation of the antenna elements reduces the intrinsic diversity capability of using extra antennas at one side. For antenna arrays and highly directive antenna radiation patterns the rank of the MIMO channel is determined by the number of distinguishable multi-path components (MPC) of the propagation channel addressed with the effective radio channel. Here, at a given multiplexing number (e.g. 2 parallel data streams) further spatial diversity can be added by creating more sophisticated beams which involve additional multipath components. In practice this means that instead of beamforming on the main Eigenbeam or the strongest multi-path, the radiation pattern could be chosen to include an additional MPC sacrificing some power fed into the strongest MPC. This exchange between maximizing the throughput on a fixed number of MIMO streams and the stabilization of the number of MIMO streams exploiting multi-path diversity, is a function and property of the antenna arrays in the device, the applied transmission and/or reception strategy (MIMO scheme) and of course the propagation channel which can in a test environment be synthesized and repeatedly replayed with sufficient statistical characteristics.

The examples given shall serve for explanations only and shall not limit the presented embodiments although they form valid embodiments. When considering the example given in connection with the MIMO system with M=N=4 configured to operate on dual streams only while using 2 more antennas than at the transmitter and the receiver for diversity to enhance and stabilize the MIMO rank, it becomes clear, that the concept of separating data streams which may be facilitated by the use of capability information and the concept of using antennas for diversity and providing and using diversity capability information may be used independently from each other but also in combination, e.g., as kind of a trade-off between using additional data streams and the corresponding resources in the network or to try to increase quality, reliability or throughput of a data stream using the antennas for diversity instead.

The diversity capability may relate to single input (SI) or multiple input (MI) as well as to single output (SO) or multiple output (MO) such that not only so-called MIMO-systems but also SIMO-Systems, MISO-Systems and SISO Systems may benefit from the techniques described.

Whilst using the benefits of diversity may at least in parts be known, the present embodiments provide for a concept to provide for knowledge at a different entity about the diversity capability on a respective other communication side, e.g., by receiving a respective signal or by testing, e.g., in a laboratory or in the field.

Assuming that a transmitting node knowns about reception diversity capabilities at the other node, it may amend its transmit strategy accordingly, e.g., with increasing capabilities at the receiver, the transmitter may illuminate an increasing area (e.g., using a broader beam or beam pattern) in which the receiver is located to provide for the possibility that the receiver may exploit additional multipath components in the channel. Correspondingly, a decrease in the capabilities may lead to a more focused area or beam or beam pattern to avoid unnecessary interference or the like for other nodes, e.g., as the additional area is expected to not provide for advantages at the receiver. Alternatively or in addition, the transmitter may, with an increase in the capability at the receiver use an increased number of antennas to send a same signal, e.g., simultaneously or according to a different scheme, e.g., transmitting a certain first number of bits or symbols on one antenna and a second number which may be different or equal to the first number, on another antenna. That is, certain data bits or symbols may be sent from the one antenna and different data bits or symbols may be transmitted from another antenna. Alternatively or in addition to a use of antennas, embodiments relate to using a different antenna port or a different beam for transmission of the additional bits or symbols.

Assuming that a receiver knowns about the diversity capability at the transmitter, it may select to use additional, less or different antennas, i.e., antenna elements, antenna panels, antenna arrays or the like, for reception diversity. For an increase in the transmitter capabilities, the receiver may, for example, decrease its efforts for reception diversity as the signal may be expected to be good enough. Alternatively, a strategy may incorporate to use an increased number of antennas to exploit the additional transmission from the transmitter.

Further, knowledge of the diversity capability at the respective other side may also allow to perform negotiation in view of the communication to be performed.

The diversity information may be provided directly to a communication partner with which the apparatus communicates or to a different entity, e.g., a central entity distributing the diversity information such that it may already be present/available when starting communication between two nodes, e.g., responsive to an association procedure or a handover.

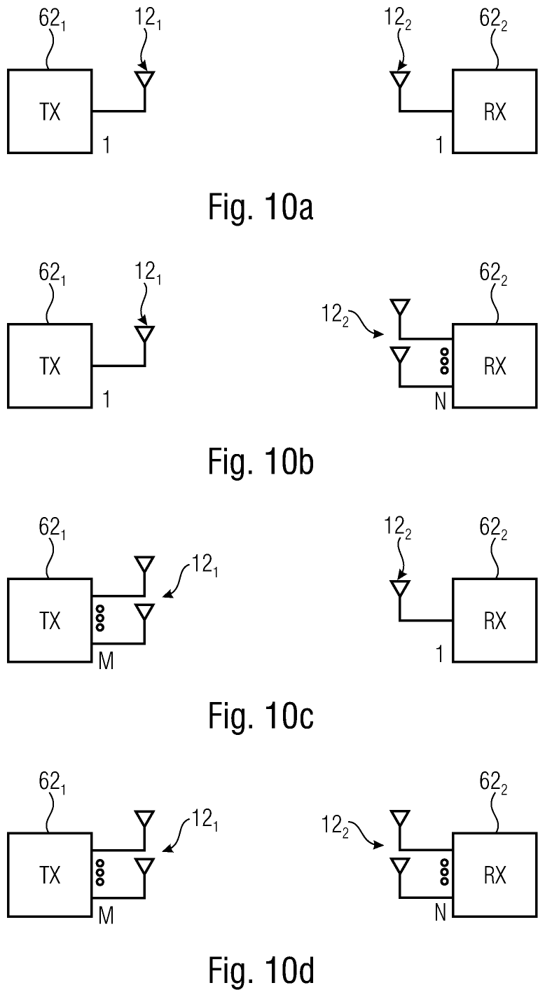

FIGS. 10a-d each schematically show a block diagram of two apparatus 62₁ and 62₂ configured for performing wireless communication with each other by use of a respective wireless interface arrangement 12₁, 12₂ respectively. Each of the apparatus 62₁ and 62₂ may be formed, for example, as an apparatus 10 or a base station 18 or 40. FIG. 10a shows a SISO (single input single output) configuration in which the wireless interface arrangements 12₁ and 12₂ each comprise a single antenna or antenna element.

FIG. 10b shows a schematic illustration of a SIMO (single input multiple output) configuration in which device 62₂ comprises a plurality of N antennas or antenna elements and, operating as a receiver as indicated by RX is able to use an increased number of antennas when compared to the scenario of FIG. 10a.

FIG. 10c shows a schematic illustration of a MISO (multiple input single output) configuration in which, when compared to the scenario of FIG. 10a, the transmitter (TX) device 62₁ comprises a wireless interface arrangement 12₁ with a number of M antennas or antenna elements. Numbers N and M may be any number larger than 1. By having a number of M antennas, device 62₁ may perform beam forming and/or channel diversity, e.g., transmit diversity.

FIG. 10d combines the multiple output of FIG. 10b and the multiple input of FIG. 10c and shows a schematic illustration of a MIMO (multiple input multiple output) arrangement in which device 62₁ comprises the wireless interface arrangement so as to have M antennas and device 62₂ comprises the wireless interface arrangement 12₂ having a number of N antennas.

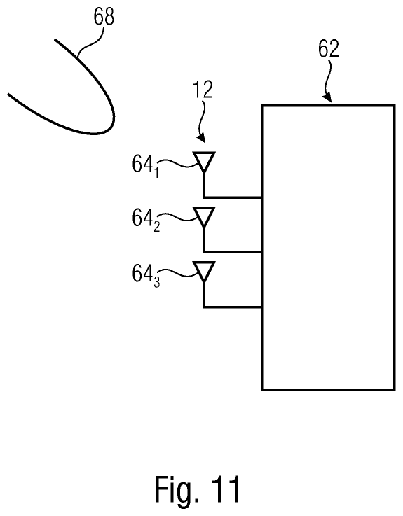

FIG. 11 shows a schematic block diagram of the apparatus 62 comprising at least one wireless interface arrangement 12 having multiple antenna elements 64₁ to 64₃. Although a single antenna element 64₂ may be sufficient to successfully receive and/or decode a wireless signal 68, a use of additional antenna elements 64₁ and/or 64₃ may support reception and/or decoding by use of diversity. A n effect similar to the illustrated receive scenario may be obtained in a transmit scenario.

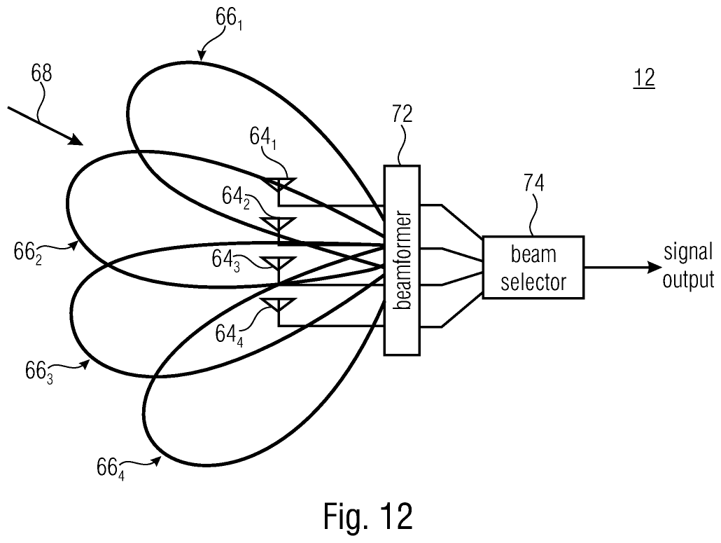

FIG. 12 shows a schematic block diagram of an example antenna arrangement 12. Antenna elements 64₁ to 64₄ may allow to form one or more beams 66₁ to 66₄ sequentially or, at least in parts, at a same time. For reception of a signal 68 a beam such as beam 66₂ may be more suitable when compared to a different beam, e.g., beam 66₄. Therefore, the antenna arrangement 12, e.g., using a beam forming network 72 and/or a beam selector 74 may operate the antenna elements 64₁ to 62₄ accordingly. In a similar way, antenna diversity may be exploited so as to allow adaptation of the receiving performance of the wireless interface arrangement 12. In other words, FIG. 12 shows a switched, multi-beam antenna array system comprised of an antenna array, a beam former and a beam selection mechanism.

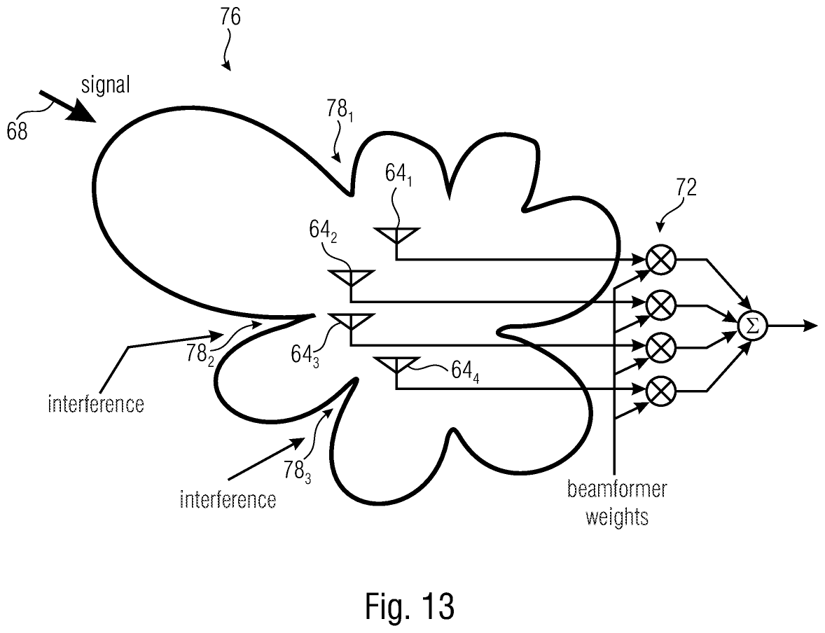

FIG. 13 shows a schematic block diagram of an example of an adaptive antenna array equipped to direct its main beam at 76 and one or more mulls 78₁ and/or 78₂ and/or 78₃, e.g., to direct the mulls towards interference and the main beam 76 and/or main lobe towards a direction of the wanted signal 68.

Adaptation of beam former weights in the beam former 72 may allow to adjust the mulls and/or lobes accordingly.

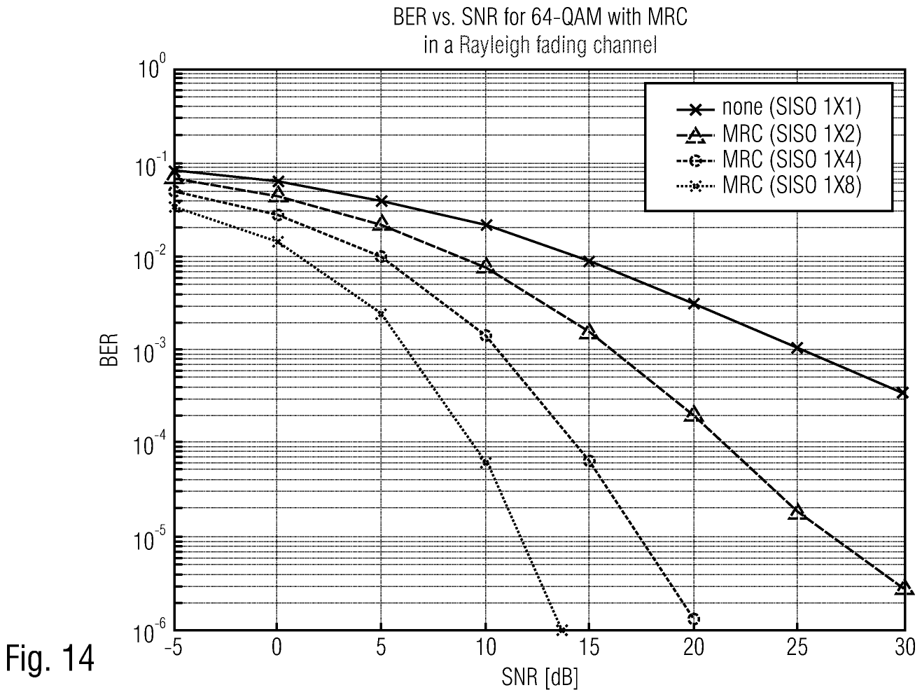

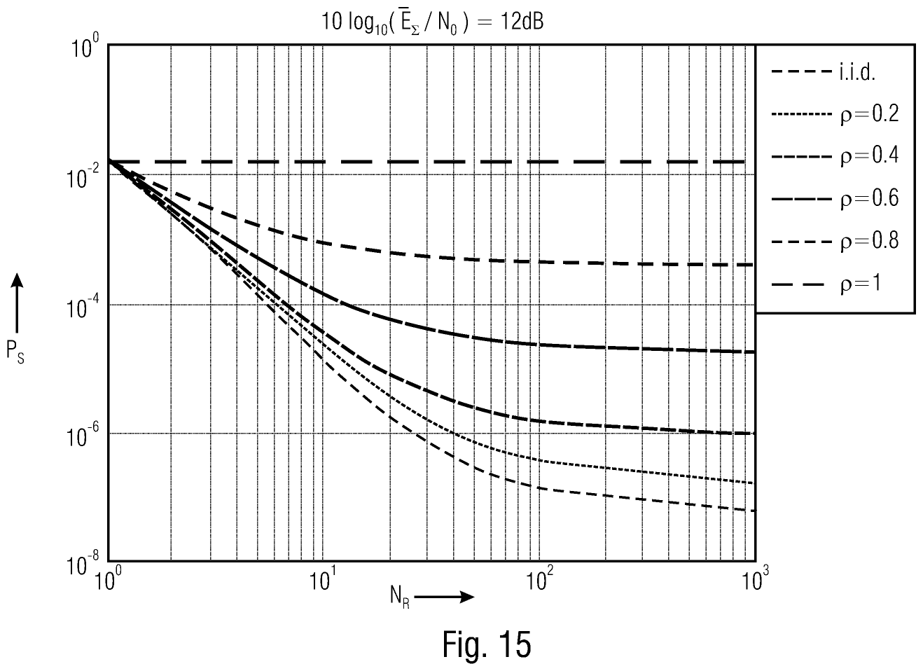

FIG. 14 shows a schematic example diagram as a waterfall plot showing a bit error rate (BER) versus a signal-to-noise-ratio (SNR) for a 64-QAM (quadrature amplitude modulation) with maximum ratio combining in a Rayleigh fading channel. The performance of SISO and 3 SIMO schemes is compared for which the one x8 SIMO, out performs the others. It may be seen, that an increased number of the multiple output decreases the BER, especially for high SNR-levels.

FIG. 15 shows a schematic block in which for a fixed signal-to-noise ratio of 12 dB measured at the input of a SIMO system, the probability of the output signal level falling below a threshold is shown as a function of both the number of receive branches, NR, and the correlation p, between them. The statistical properties of the branches are both independent and identically distributed (plot i.i.d.). When ρ=0, the branches are mutually independent, thus yielding the best performance. As p is increased, the mutual independence of the two branches is reduced and the probability of the output signal falling below the threshold is increased. In the limit, when ρ=1, the two branches are identical and no diversity gain can be achieved, regardless of the number of branches that are combined.

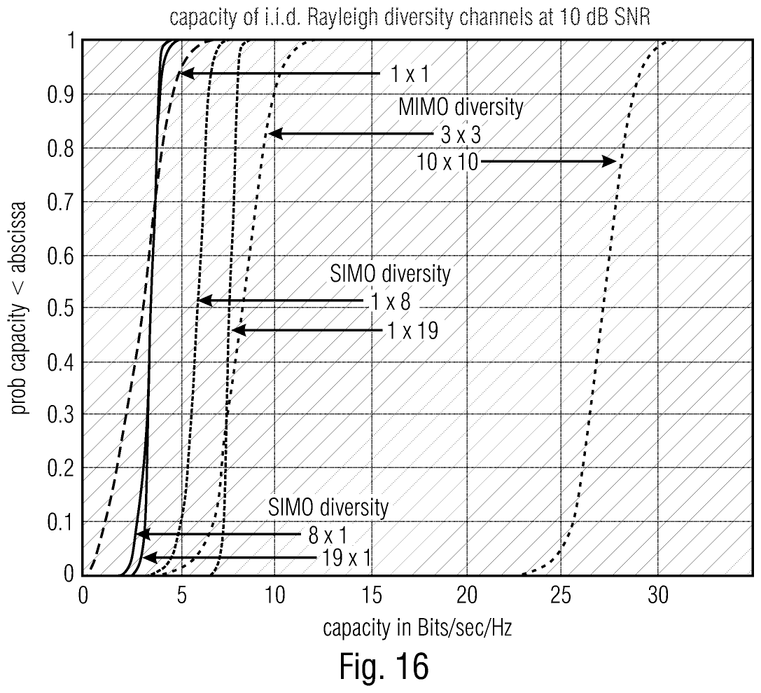

FIG. 16 shows a comparison of a performance of various schemes, therein a SISO (1×1), SIMO (1×8, 1×19), MISO (8×1, 19×1) and MIMO (3×3, 1×10), in which the signal-to-noise ratio measured at the input of the system is fixed. The capacity of the i.i.d. Rayleigh diversity channels at 10 dB SNR is shown. It may be seen, that the 10×10 implementation comprises the highest capacity amongst the examined values. Those are only examples to be implemented in the embodiments described herein.

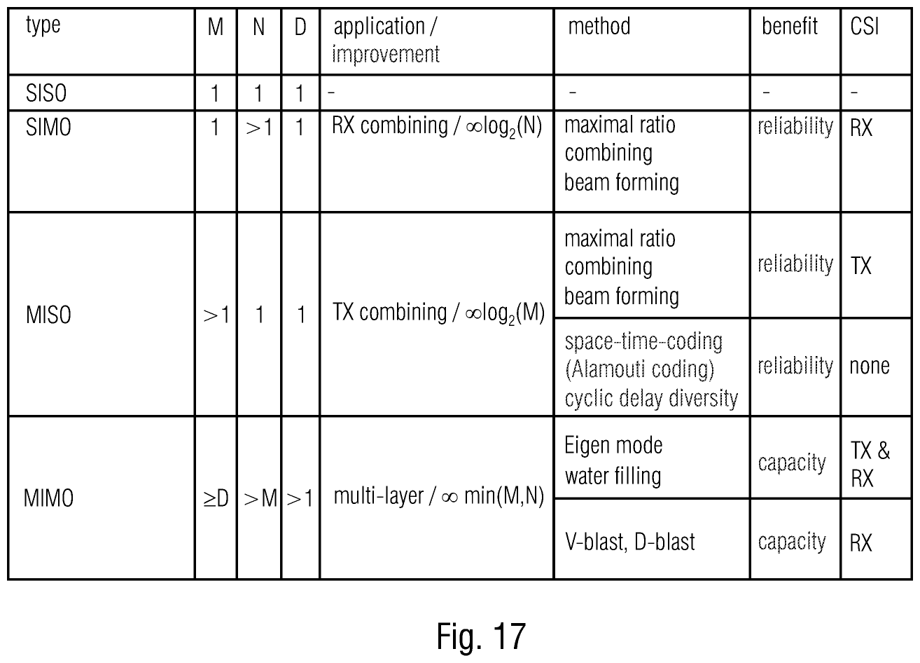

FIG. 17 shows a schematic illustration of a table illustrating a summary of SISO, SIMO, MISO and MIMO that relaxes their performance to the number of antennas and layers where M is the number of TX antennas, N is the number of RX antennas and D is the number of layers. The column CSI represents a channel state information and shows where it is needed.

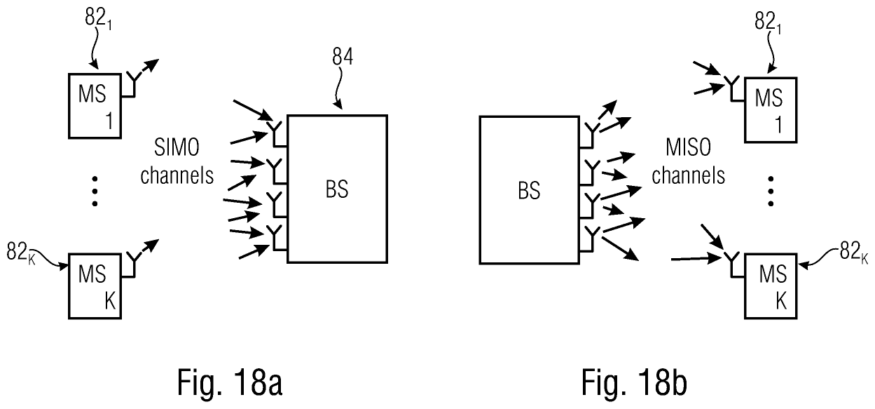

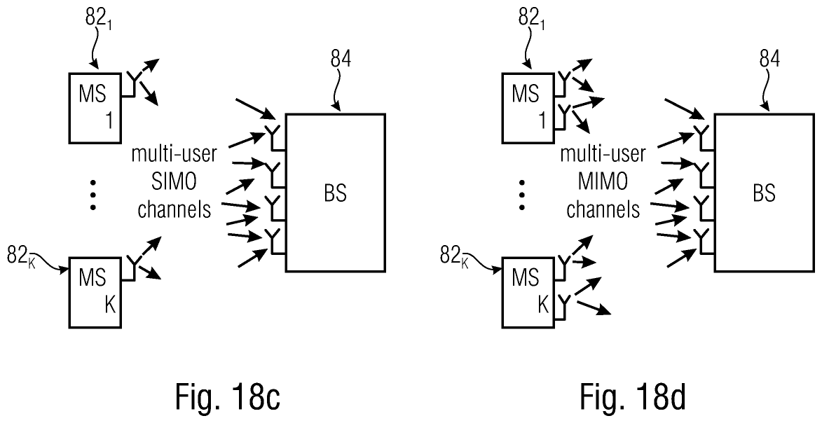

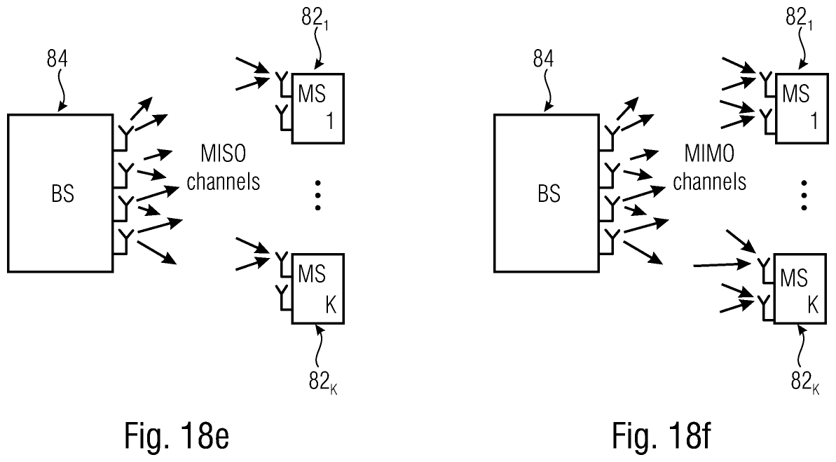

FIG. 18a shows a schematic block diagram of a mobile device or a mobile station (MS) performing a SIMO communication with a base station 84 as well as other devices 82 of a set of K devices. FIG. 18a shows a schematic illustration of an uplink transmission, whilst FIG. 18b shows a schematic representation of a downlink transmission in a corresponding mobile cellular network. By way of example, the devices 82 are equipped with a single antenna each.

FIG. 18c shows a schematic illustration of a multi-user multiple-axis channel, i.e., a MU-SIMO MAC.

FIG. 18d shows a schematic illustration of a MU-MIMO MAC in which the devices 82₁ to 82ₖ may comprise more than a single antenna.

Corresponding to an uplink MAC scenario, the downlink transmission from the base station to several mobile terminals or mobile stations may be referred to as a multi-user broadcast channel (MU-BC). This may consider the fact that in principle all users may receive every message sent by the base station when considering a broadcast. Here, again, the devices 82 can have only one or may have several antennas for the reception. Again, the base station may perform all spatial signals processing since the devices 82 (in particular while having one antenna per device) are not able to perform joint detection and can therefore be low price devices. The channel state information needed to perform spatial pre-processing may be obtained in different ways, e.g., by measuring the channel in the opposite direction and exploiting the channel reciprocity, e.g., in time division duplex, TDD.

FIG. 18e shows a schematic diagram of a multi-user broadcast channel as an MU-MISO broadcast (BC).

FIG. 18f shows a schematic block diagram of a MU-MIMO BC. As other scenarios described herein, e.g., the scenarios of FIGS. 10a-18e, also the scenario of FIG. 18f may benefit from the embodiments described herein.

Embodiments may use a rank and/or condition number of a channel implemented in the wireless communication networks relying on the presented embodiments. One may assume a single value decomposition of the channel H

H=U·D·V^{H}

where U and V are unitary matrixes and D has only diagonal entries in the upper square sub-matrix. The non-negative real entries on this diagonal are called singular values. The number of singular values which are greater than zero denote rank (H).

The fraction between the biggest singular value and the smallest non-zero singular value is called the condition number of H which one may denote COND (H). The condition number may provide a measure about the quality ratio between the best and the worst sub-channel. This may be of importance if an inversion of H is needed, e.g., for zero forcing detection in a multi-antenna system. A matrix is called singular when some columns or rows are linearly dependent from each other or one column/row can be decomposed as a linear combination of some other columns/rows.

It is to be noted that in practice the number of non-zero singular values (SV) is replaced by the number of valid or useful SVs. Here, valid or useful SVs has to be understood under certain side constraints, e.g., the dynamic range of a given transmission scheme or the achievable SNR for data transmission. Those factors might limit the number of data streams which can be multiplexed over the transmission channel and thus, can be significant view than non-zero SVs.

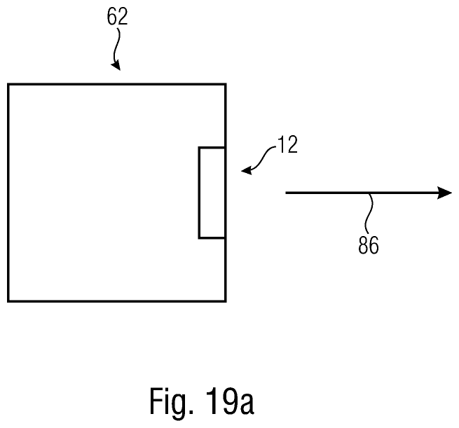

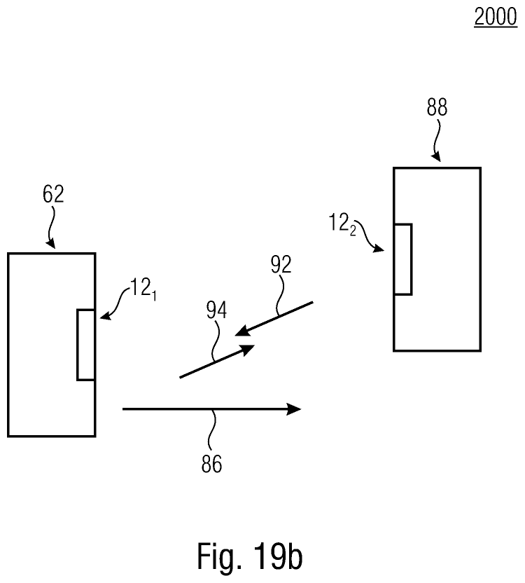

FIG. 19a shows a schematic block diagram of an apparatus 62 in accordance with the aspect of exploiting channel diversity. Apparatus 62 may comprise the wireless interface arrangement 12 or a different wireless interface arrangement. In particular, device 62 may be configured or able, but is not needed to maintain two spatial data streams at a same time. It is sufficient for the aspect of exploiting diversity information to maintain a single data stream.

Apparatus 62 is configured for wireless communicating in a wireless communication network as described for device 10 and/or device 20. The wireless interface arrangement 12 may allow for wireless communication of device 62 in such a network environment by maintaining one or more data stream, e.g., spatially separated data streams. The apparatus is configured for wireless transmitting, to a receiving apparatus such as a device 10, 20, 24 or the like and/or a base station such as base station 18 and/or 40, a diversity signal 86 indicating a diversity capability of the apparatus 62. The diversity capability may relate to a capability of the apparatus to perform diversity in a radio channel of the wireless communication, i.e., a radio channel diversity (RCD). The diversity signal 86 may, thus, indicate the RCD capability.

It is possible but not necessary that the apparatus may perform diversity for the wireless communication. The diversity signal 86 may also contain information that the apparatus 62 is unable to perform diversity during transmission and/or reception of a signal. Even such information may be beneficial at the receiving entity and/or the network coordination such that benefits may also be obtained when apparatus 62 does not support transmit diversity and/or received diversity.

That is, apparatus 62 may be configured for transmitting the diversity capability information so as to indicate whether or not the apparatus is configured for using a reception diversity for the wireless communication and/or a transmission diversity for the wireless communication.

The diversity information contained in the diversity signal 86 may be a binary signal having a meaning according to true/false, able/unable, supported/unsupported or the like but may also comprise a more granular information. For example, apparatus 62 may be configured for transmitting the capability information so as to indicate a degree of diversity supported by the apparatus. The degree may be indicated, for example, by a number of additional antenna elements that may be used for antenna diversity, a measure of a bit error rate or the like that may be achieved or varied and/or other suitable measures.

Apparatus 62 may be configured for transmitting the RCD capability information so as to indicate an RCD scheme supported by the apparatus. Such a spatial diversity scheme may include, for example, one or more of:
Space/time coding
Antenna/antenna pair switching
Selection diversity, e.g., choose a higher RSSI (received signal strength indicator)
Equal gain combining (EGC)
Maximum ratio combining (MRC)
Cyclic delay diversity (CDD)
Beam sweeping
Beam switching
Maximum ratio transmission
Switched Eigen beam/Eigen space mapping
Round robin transmit antenna selection
Variable delay per antenna port mapping
Subset selection of beams or antennas
Frequency diversity alone or in combination with spatial diversity
Polarization selection, switching or the like
Other diversity schemes

That is, device 62 may not only transmit/signal/indicate/report whether it supports diversity or not or indicate whether a degree of diversity but may also indicate the mechanism being used for the diversity, i.e., the RCD scheme.

Apparatus 62 may be configured for transmitting the RCD capability information so as to indicate a plurality of RCD schemes supported by the apparatus. This may also allow a receiving entity and/or an interacting entity such as a base station or a communication partner or a network controller, to select or at least suggest an RCD scheme to be used by the apparatus. This may be supported as providing such a deciding or suggesting entity with the information which schemes are supported or considered to be appropriate by device 62. In particular, the latter, the evaluation which scheme is deemed to be appropriate, may form a basis for a negotiation between device 62 and another device.

For example, the apparatus 62 may be configured for applying a selected RCD scheme for further wireless communication responsive to a reception of a selection signal indicating the selected RCD scheme from the plurality of RCD schemes. That is, apparatus 62 may receive a feedback signal responsive to having transmitted signal 86 or a different signal indicating the RCD schemes supported and may operate accordingly.

FIG. 19b shows a schematic block diagram of the wireless communication scenario 2000 in accordance with embodiments. The apparatus 62 may be present in the wireless communication environment 2000 together with a further apparatus 88. The apparatus 88 may be adapted for a wireless communication and may be implemented, for example, as device 10, 20 and/or 62, for example. From apparatus 88, apparatus 62 may receive a request signal 92 indicating a request to perform a specific RCD scheme. Apparatus 62 may perform negotiation with apparatus 88 about the specific RCD scheme to identify a negotiated RCD scheme. Apparatus 62 may be configured for applying the negotiated RCD scheme. One way of a possible negotiation is to indicate the supported or possible RCD schemes, for example, using diversity signal 86 or a different signal. Request signal 92 may select one of the indicated RCD schemes or at least a subset thereof, e.g., indicating a selection of the RCD schemes favored or at least supported or usable or exploitable by apparatus 88. Apparatus 62 may implement the single indicated RCD scheme of signal 92 and/or may perform a selection from a set of RCD schemes indicated in the request signal 92.

A selection and/or confirmation with regard to the request signal 92 may be transmitted by apparatus 62 by transmitting a message 94 indicating the negotiated RCD scheme. Apparatus 62 may transmit message 94 immediately after having made the decision or at a later time. For example, apparatus 62 may delay transmission of the message 94 until the offer is outdated due to real-time constraints. Such an offer may refer to, for example, the number of antenna ports that the device offers its partner, e.g., when transmitting the RMC and/or RCD capability based on a selection from the device. Such an offer might become outdated due to a change of operating conditions or a change of radio channel conditions. The offer may, according to embodiments, be responsive to a request being received but also be transmitted during an (initial) exchange of information, i.e., without request. In case the offer or the response become outdated, e.g., based on real-time constraints or the environment, use-case, orientation, . . . of the device, then the benefit that was expected when offering a respective capability might have changed either for the better or the worse presuming that the (outdated) offer was nevertheless accepted (even though it was out of date). That is, a device may transmit an update, a new capability message and/or an updated offer.

Another way of negotiation which may be performed in combination or as an alternative, may be implemented in a way that the apparatus 62 is configured for applying a specific RCD scheme for a transmission and/or a reception of a signal. Apparatus 62 may be configured for receiving feedback information from apparatus 88, the feedback information indicating an effective quality of the specific RCD scheme. For example, signal 92 may, as an alternative or in addition to the request, provide apparatus 62 with information relating to a performance of the RCD schemes supported by apparatus 62 and/or indicated in signal 86.

Apparatus 62 may be configured for maintaining, optimizing or changing the specific RCD scheme in a further transmission from the first apparatus to apparatus 88 responsive to the feedback signal. That is, by obtaining knowledge about the performance of the RCD schemes, apparatus 62 may adopt its choice. Such a mechanism may be applied in both directions, from apparatus 62 to apparatus 88 or vice versa. Therefore, the feedback information may comprise a first message part indicating the received/observed RCD quality/diversity degree of the one link direction and/or may comprise a second message part indicating the applied transmission RCD into the opposite link direction and/or a third message part indicating a request to the second apparatus to apply a specific RCD for reception and/or transmission.

Apparatus 62 may accordingly also provide apparatus 88 with such information regarding the RCD schemes supported by apparatus 88, e.g., when apparatus 88 comprises a same or similar functionality when compared to apparatus 62 in view of channel diversity. For example, apparatus 62 may be configured for determining a feedback information indicating an effective quality of a specific RCD scheme usable for transmission from apparatus 88 to apparatus 62, wherein apparatus 62 may transmit the feedback information to apparatus 88.

According to an embodiment, apparatus 62 may transmit a request to apparatus 88 to apply a specific RCD scheme.

According to an embodiment, apparatus 62 may be configured for selecting the specific RCD scheme from a plurality of RCD schemes. The plurality of RCD schemes may be known to apparatus 62 based on observations made with apparatus 62 and/or knowledge about an RCD capability of apparatus 88. Such knowledge may be obtained by a signal received from apparatus 88, e.g., a signal corresponding to single 86, and/or by obtaining information from a database which may be accessible within the wireless communication environment 2000.

By use of signals 86, 92 and/or 94, information may be transferred from one apparatus to another with regards to capabilities and/or requested behaviours of an apparatus. Apparatus 62 may be configured to adapt a control of the wireless interface arrangement 12 for the communication within the RCD capability indicating in the RCD signal 86. That is, signal 86 may indicated the behaviour or at least a space of possible behaviours of apparatus 62 and apparatus 62 may operate accordingly.

According to an embodiment, device 62 may reconfigure its diversity scheme as indicated in the RCD signal 86 sent and/or in a corresponding signal received.

At this stage, it has to be noted that signal 86 may be transmitted directly to apparatus 88 but may also be transmitted to a different entity of wireless communication environment 2000 which may forward the information to apparatus or may store such information accessible for device 88.

When referring again to signal 92 as a kind of request, there may also occur an even in which apparatus 88 requests a specific behaviour, application of a specific RCD scheme which is not supported by apparatus 88 or deemed to be inappropriate or the like. Alternatively or in addition, other reasons may occur that might lead apparatus 62 to deviate from a received requested. Whilst apparatus 62 may operate according to the request in a case where it is capable of implementing the indicated specific RCD scheme and when the request indicates to apply such a specific RCD scheme, a different behaviour is described in the following. It is to be noted that the request 92 may be received responsive or independent from diversity signal 86. That is, even without having any knowledge about the capability of device 62, apparatus 88 may request device 62 to implement a specific RCD scheme which may provide for a further possibility that apparatus 62 is not capable to follow the request or may consider to deviate the request for other reasons.

For example, the apparatus 62 may be configured for receiving a request signal from apparatus 88, the request signal indicating a request to apply a specific RCD scheme. However, due to any reasons, the apparatus might be incapable of implementing the specific RCD scheme. Such a situation in which the device is incapable may be a temporary situation or a permanent situation. For example the RCD capability of apparatus 62 may vary over time, e.g., based on a direction towards a beam is to be formed or the like. Alternatively, the request may refer to a specific RCD scheme for which the apparatus 62 is not even implemented. In such a case, the apparatus may decide to deviate from the request. Alternatively or in addition, apparatus 62 may receive more than just one request, a plurality of requests from different apparatuses. The requests may indicate a plurality of possibility contradicting specific RCD schemes and apparatus 62 may determine an amended RCD scheme to deviate from the received request based on the capability of the apparatus. Thereby, the apparatus 62 may deviate from more than just one received request. For example, the apparatus may decide which request to follow and/or may decide for a combined solution or behaviour to follow more than just one request to at least a part. For example, the request 92 may also indicate auxiliary schemes to be implemented as an auxiliary measure with regards to a main request. For example, apparatus 62 may decide for a specific RCD scheme that allow for an increase of transmission quality for a high or optimum number of apparatuses.

According to an embodiment, the apparatus 62 may be configured for receiving a request signal such as request 92. The request signal may indicate a request to apply a specific RCD scheme, wherein apparatus 62 may be configured for receiving a plurality of contradicting requests indicating a plurality of contradicting specific RCD schemes. Apparatuses 62 may determine a combined RCD scheme as a combination of the requested plurality of RCD schemes. The aspect of exploiting and exchanging information in connection with the RCD may be combined with the aspect of the channel maintenance capability, the radio channel multiplexing capability respectively. That is, an apparatus may maintain one or more data streams and/or may perform channel diversity, i.e., RCD. In the following, the signal maintenance capability is also referred to radio channel multiplexing (RCM) capability. That is, the RCM capability is used synonymously for the signal maintenance capability. When combining both aspects, i.e., the RCD capability and the RCM capability, an apparatus may be configured for wirelessly transmitting, to a receiving apparatus, a capability signal comprising a capability information indicating a corresponding RCM capability of the apparatus. That is, the aspect of indicating the RCM capability and the aspect of indicating the RCD capability may be performed independently or in combination.

One aspect of the RCM capability was described in connection with generating the capability signal 16 such that the capability information contained therein indicates a maximum number of spatial data streams being utilizable simultaneously with the wireless interface arrangement. This maximum number may be associated, in view of the RCD capability, with an associated RCD scheme and may be different for different RCD schemes, i.e., may have a first number for a first RCD scheme and a second number for a second RCD scheme. That is, when implementing different RCD schemes, a different amount of spatial data streams is possibly maintainable. Vice versa, a number of spatial data streams to be maintained with the apparatus may influence the RCD scheme and/or a number of antenna elements to be used for channel diversity. Apparatus 62 may decide on one of both, thereby rendering the other capability as being dependent on the first selection. For example, the multiplexing degree may be chosen independently or it may be different from the maximum achievable multiplexing gain/degree and extra antennas may be used for diversity contributions by device 62 and/or 88. Alternatively or in addition, for a given/diversity scheme, the achievable/remaining degrees for multiplexing may be a maximum number while by choosing a different RCD scheme, the remaining achievable multiplexing degree may differ.

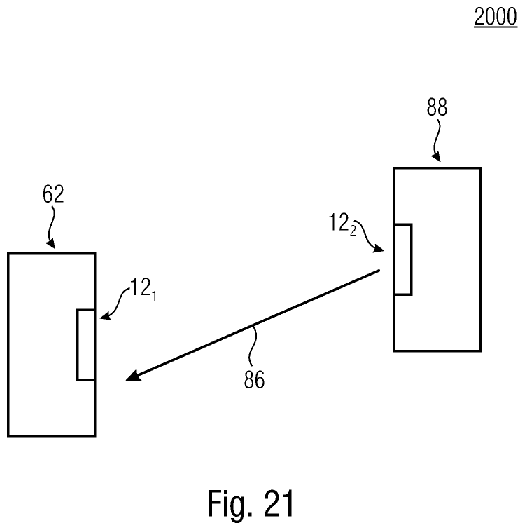

In connection with FIG. 19a and FIG. 19b, aspects are described that outline how apparatus 88 may exploit the information provided by apparatus 62. Such a functionality may also be incorporated into apparatus 62. That is, apparatus 62 may be configured for wirelessly receiving a diversity signal, e.g., from apparatus 88, as shown in FIG. 21 illustrating a schematic block diagram of the wireless communication environment 2000 in which apparatus 88 transmits diversity signal 86 to apparatus 62 directly or indirectly. The diversity signal 86 may, in this case, indicate or at least relate to a capability of the apparatus 88 to perform diversity for the wireless communication.

Apparatus 62 may be configured for receiving a signal from a communication partner indicating a diversity configuration and to adapt control of the wireless interface 12₁ in accordance with diversity configuration. Such information may be contained in diversity signal 86 and/or may be contained in a different signal. That is, apparatus 62 may obtain knowledge about the RCD scheme being implemented at device 88 and may adopt its own control of the wireless interface arrangement 12₁ based on this knowledge to improve wireless communication.

Apparatus 62 and/or apparatus 88 may be configured for transmitting the diversity signal periodically, e.g., once within a frame, once within a second or any other period of constant or variable time. For example, a period being based on events may also form a period which is, however, not based on the time that has lapsed but on the event. Alternatively or in addition, the diversity signal 86 may be transmitted responsive to having determined the change or responsive to a request received with the wireless interface arrangement.

Apparatus 62 may comprise a data memory having stored thereon the capability information. That is, the information contained in signal 86 may be retrieved from such a data memory. The diversity signal 86 may be transmitted in a logical channel, a transport channel, a physical layer data channel, a physical layer control channel, a new radio control channel, or any other mechanisms allowing to exchange information.

As described in connection with FIG. 19a, 19b and FIG. 21, apparatus 62 may not only provide another apparatus with the diversity signal 86 but may also receive such a signal and may exploit its content. Receiving such a content may be performed in combination or independently from transmitting diversity signal 86. That is, such an apparatus, i.e., apparatus 88 in FIG. 19a or 19b or apparatus 62 in FIG. 21 may be configured for obtaining an RCD information indicating an RCD capability of a respective communication partner, i.e., of device 62 in FIG. 19a and FIG. 19b, of device 88 in FIG. 21. The RCD capability may relate to a capability of the transmitting apparatus to perform diversity for the wireless communication, e.g., for transmission and/or reception. The receiving apparatus may be configured to adapt a control of its wireless interface arrangement for a communication with the communication partner based on the RCD capability. Alternatively or in addition, the communication partner may adopt its wireless communication scheme based on the RCD capability of the apparatus or based on the RCD capability of the other apparatus or the combinatory based on the RCD capability of both apparatus. That is, each of the apparatus 62 and/or 88 may adapt its control of the wireless interface arrangement 12₁, 12₂ respectively responsive to transmitting the signal and/or responsive to receiving the signal.

For example, the apparatus 62 or 88 may be configured for wirelessly receiving a diversity signal comprising the RCD information to obtain the RCD information. Alternatively or in addition, an apparatus may perform a test procedure with the communication partner during which a diversity scheme of the apparatus and/or the communication partner is changed at least one time. That is, the RCD capability may be tested in the field and/or during operation. Such a test procedure may be performed once and/or iteratively and is described later in more detail.

When referring again to wireless communication environment 2000, apparatus 62 and 88 may implement a transmit strategy within an RCD scheme whilst the other node implements a receive strategy within its RCD capability. By way of example, apparatus 62 may implement a transmit strategy and apparatus 88 implements the receive strategy. The roles of apparatus 62 and 88 may be changed without limitation and/or the apparatus 62 and/or 88 may implement both, a transmit strategy and a receive strategy.

For example, at one instance in time, apparatus 62 and apparatus 88 may implement a pair of a transmit strategy and a receive strategy. This may return a specific measure for equality of this combination. By changing the transmit strategy of apparatus 62 and/or the receive strategy of apparatus 88, a different combination may be obtained for which a different measure may be determined. While obtaining two or more combinations, two or more quality measures may be obtained allowing some sort of ranking or determination which combination to be used for further communication.

Apparatus 62 and/or 88 may comprise an RCD capability and may be configured for adapting the control of the respective wireless interface arrangement 12₁, 12₂ respectively based on the RCD capability of the communication partner and the own RCD capability.

The apparatus receiving the diversity signal may be adopted for evaluating the signal for an indication of a plurality of diversity schemes supported by the communication partner that has provided for the RCD capability information. The receiving apparatus may select one of the indicated diversity schemes as a selected diversity scheme and may transmit a selection signal to the communication partner indicating the selected diversity scheme. For example, such a selection signal may be implemented by use of the request signal 92. However, the selection signal is not limited to a single RCD scheme but may also contain a subset of the indicated RCD schemes which are indicated in the kept diversity signal 86.

The receiving apparatus may itself comprise an RCD capability may be configured for selecting the selected diversity scheme based on the own RCD capability. Alternatively or in addition, the apparatus may select the selected diversity scheme as a result of an optimization process optimizing the communication of the apparatus with a plurality of communication partners comprising the communication partner. That is, the receiving apparatus may consider its communication to further apparatus and may request the apparatus providing diversity signal 86 so as to obtain an optimized communication for all communication partners.

According to an embodiment, the receiving apparatus is configured to adopt the controller of the wireless interface arrangement for the communication with the communication partner for transmitting a signal to the communication partner and/or for receiving a signal from the communication partner. That is, the receiving apparatus, an apparatus 88 in FIGS. 19a and 19b or apparatus 62 in FIG. 21 may adapt its control for receiving purpose or transmission purpose to exploit a respective radio channel diversity.

According to an embodiment, adopting the control relates to at least one of:
a number of antenna ports used for reception;
a number of antenna ports used for transmission;
a number of physical antennas used for reception;
a number of physical antennas used for transmission;
a number of beams used for reception;
a number of beams used for transmission;
a direction of transmission beam(s);
a direction of reception beam(s);
a selection of a transmission scheme, e.g., diversity, multi-stream;
a selection of a reception scheme, e.g., diversity, multi-stream;
a selection of a frequency/bandwidth part (BWP)/resource block/subcarrier used for transmission and/or reception;
a selection of panel(s) of the wireless communication interface used;
a selection of polarization

Some of the embodiments described herein relate to adjusting communication for an unidirectional communication. However, the advantages obtained with the just described aspect may also be used in a bidirectional way. That is, the receiving apparatus 88 in FIGS. 19a and 19b or 62 in FIG. 21 may determine a diversity scheme for a reception with the wireless interface and may determine, based on the diversity scheme for a reception with the wireless interface a diversity scheme for a transmission with the wireless interface based on a diversity correspondence between reception and transmission. That is, by having determined a receive strategy, based on an assumption of correspondence, a corresponding transmit strategy may be determined. This may be implemented, as an alternative or an addition, in the other way. That is, the apparatus may determine a diversity scheme for a transmission with the wireless interface and for determining, based on the diversity scheme for a transmission with the wireless interface a diversity scheme for a reception with the wireless interface. This may rely on a diversity correspondence between reception and transmission which may allow for determining a consistent or corresponding solution for both ends of the link.

According to an embodiment, the apparatus may be configured for jointly evaluating the RCD capability of the communication partner and an own RCD capability. The apparatus may derive a solution for a first diversity configuration of the own wireless interface arrangement and for a second diversity configuration of a wireless interface arrangement of the communication partner. The apparatus may implement the first diversity configuration, i.e., the solution determined for the own wireless arrangement. As an alternative or in addition, the apparatus may transmit a signal to the communication partner indicating the second diversity configuration.

According to an embodiment, the apparatus may derive the solution based on at least one of:
a capacity of a link between the apparatus and the communication partner;
a reliability of a link between the apparatus and the communication partner;
a throughput of a link between the apparatus and the communication partner;
a spectral efficiency of a link between the apparatus and the communication partner;
a power efficiency of a signal transmission between the apparatus and the communication partner;
a user density in an area of the communication partner and/or the apparatus;
an antenna pattern used in a link between the apparatus and the communication partner;
a beam direction used in a link between the apparatus and the communication partner;
an interference reduction of a link between the apparatus and the communication partner.
Statistics of the effective radio channel

According to an embodiment, the apparatus is configured for deriving the solution from events in the past, events in the present and predictions about events in the future. That is, for example, an orientation, a location, an occupied channel in the past, in the present, and/or a respective expectation in the future may be considered for deriving the respective solution. Events may relate to any change of an operation, a condition or an environment of the device, e.g., an established beam direction; an orientation; a measured signal-to-noise ratio; a measured carrier-to-noise ratio; a measured signal-to-interference ratio; a measured carrier-to-interference ratio; a channel quality indication; a channel capacity indication; a spectrum usage; a capacity usage; a reliability requirement, other events and/or combinations thereof.

According to an embodiment, the apparatus may be configured for receiving a capability signal comprising a capability information indicating an RCM capability of the apparatus to separate at least one data stream and for selecting the diversity scheme based on the capability information. That is, the cross relationship of using antenna elements for at least one data stream and/or for radio channel diversity may be considered.

According to an embodiment, the apparatus is configured for receiving a capability signal comprising a capability information indicating the RCM capability of the communication partner. The apparatus may be configured for using a set of data streams from the plurality of data streams for communicating with the communication partner and may be configured for selecting the set of data streams based on the capability information.

For example, the apparatus may be configured for adaptively adapting the set of data streams responsive to a feedback information receiving from the communication partner. The feedback information may indicate a data transmission quality of the data transmission between the apparatus and the communication partner. The apparatus may be configured for determining that a transmission quality is below a desired transmission quality and may adapt the set of data streams so as to increase the transmission quality of the data transmission within the RCM capability of the communication partner.

The apparatus described in connection with this aspect, e.g., device 62 and/or device 88 may be implemented as a user equipment, an internet-of-things device as a base station and/or a relay or any other node for performing a wireless communication in a wireless communication network. Embodiments, thus, also relate to a wireless communication network, e.g., incorporating the wireless communication environment 2000.

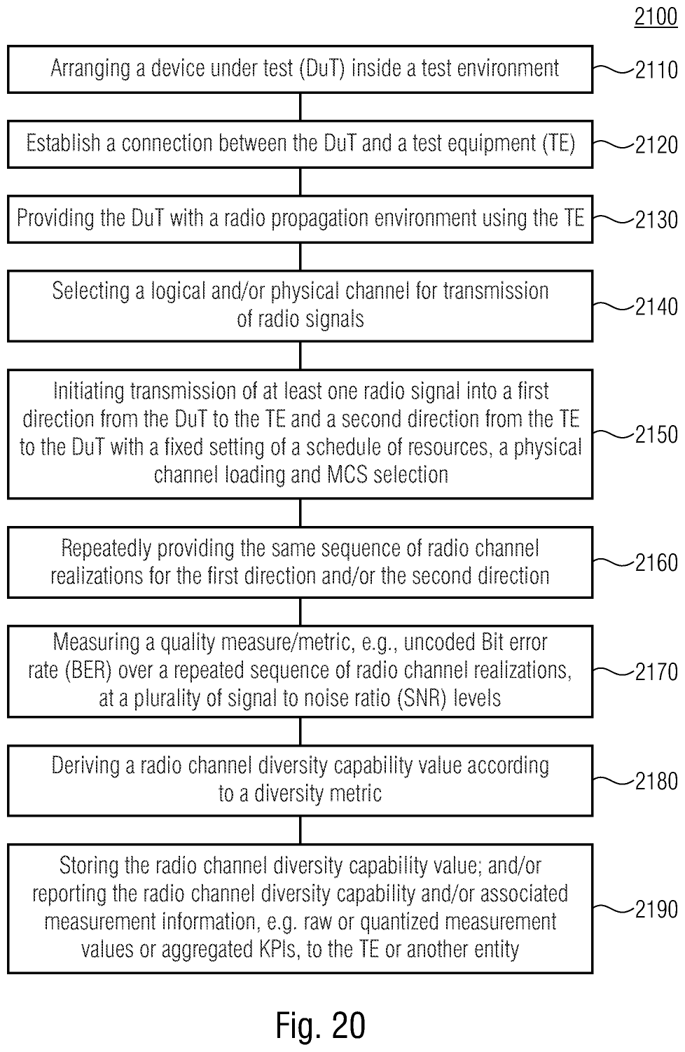

FIG. 20 shows a schematic flowchart of a method 2100 in accordance with embodiments. At 2110, a device under test is arranged inside a test environment. At 2120, a connection between the device under test (DuT) and a test equipment (TE) is established.

At 2130, the DuT is provided with a radio propagation environment using the TE. That is, additional links and/or interference and/or scattering may be generated and/or simulated.

At 2140, a logical and/or physical channel is selected for transmission of radio signals. This channel may be in accordance with the radio propagation environment of 2130.

In 2150, transmission of at least one radio signal into a first direction from the DuT to the TE and/or from the TE to the DuT is initiated with a fixed setting of a schedule of resources of the radio propagation environment. That is, for example, a resource allocation, e.g., where particular reference signals, control signals and/or user data is mapped how it is encoded/protected by the MCS or user, a link or group of specific encryption may be known to the receiver and therefore may be exchanged before or during the measurement using known resource allocation mappings. Further, a physical channel loading, i.e., data load and the like as well as an MCS (modulation coding scheme) selection may remain fixed. In other words, a similar signal or signals with similar signal statistics may be transmitted. For example, when measuring BER the data can be unchanged but also changed. A change may be suitable, as long as the content is known for comparison how many bits were received wrong. This can be achieved by e.g. a random sequence generator with a known seed. As a result the data transmitted may be random and therefore different in different time instances but still known in view of the BER measurement because of the structure of the sequence, e.g., m-sequence and a particular known and shared seed to start the sequence which arrives at a same signal statistics.

At 2160, the same sequence of radio channel realizations is provided repeatedly for the first direction and for the second direction. That is, the test environment may provide different radio channel realizations sequentially and may repeat this sequence.

At 2170, a quality measure/metric may be measured, e.g., an encoded bit error rate (BER), which may be represented as a respective curve and which may be compared over a repeated sequence of radio channel realizations, e.g., the one provided in 2160, and at a plurality of signal-to-noise ratio (SNR) levels.

At 2180, a radio channel diversity capability value may be derived from the obtained results according to a diversity metric. For an example two antenna system, a diversity metric could take the form of a scalar value in the range of 0 to 1 where 0 represents complete decorrelation and 1 represents complete correlation. Increasing values greater than 0 and less than 1 may correspond to increasing measures of correlation. For an example multiple antenna system using more than two antennas, a diversity metric could take the form of a matrix of correlation values, each element corresponding to the correlation between antenna m and antenna n where there are in total N-by-M antennas.

As an alternative, the metric could take the form of being a quantized value where, for example, “low correlation” could relate to, by non-limiting example, values of C in the range of 0.0≥C<0.3, “medium correlation”, 0.3≥C<0.6 and “high correlation” 0.6≥C≤1.0.

However, a consideration of only the (signal/antenna) correlation could be misleading as it might ignore differences in the mean (power) level of the signals produced by different antennas when receiving EM waves that have equal energy. This could be due to a difference in the radiation efficiency of the antennas which had an effect on their gain.

A more comprehensive measure may therefore be implemented in embodiments to take this effect into account or, in other words, combine both the correlation between antennas and their gain. Since the latter is itself a function of the spatial coordinates—due to the antennas' radiation pattern—an average gain value or a mean-effective gain (MEG) value is needed.

A further consideration is the relationship between the correlation of the patterns of two antennas and correlation of the signals produced by two antennas. In both the former and the latter, a range of solid angles is advantageously to be defined since, for example, it is unlikely that anything other than two isotropic radiators will have identical correlation values when computed from a hemispherical of their patterns, no matter which hemisphere is considered (upper, lower, forward, backward, left or right).

In 2190, the radio channel diversity capability value is stored and/or reported. As an alternative or an addition to reporting the channel diversity capability or capability value, associated measurement information may be provided, e.g., raw or quantized measurement values or aggregated key performance indicators (KPIs). Reporting may refer to a transfer of information to the TE or another entity.

By implementing method 2100, a radio channel diversity capability in a radio link between two nodes may be determined. For example, the results may form a basis for data to be stored in a device, e.g., device 62, to provide the device with knowledge about its radio diversity capability.

At least some of the steps may be performed in a different order. For example, the DuT may be provided with a radio propagation environment prior to establishing a connection. Further, the selection of the logical and/or physical channel and the corresponding decisions and/or implementations may be performed at a different stage as long as it is performed prior to providing the physical channel for measurement. That is, FIG. 21 does not necessarily define a sequence of the steps.

Method 2100 may be performed in various ways. In one example, 2170 comprises to vary the SNR level. To obtain the plurality of SNR levels, the method may comprise varying the SNR level between repetitions of providing the sequence of radio channel realizations by controlling the SNR using a noise and/or interference generator in the TE. Alternatively or in addition, the power of the transmitted signals may be varied, thus, including an automatic gain control of the receiver and/or a receiver quantization in the measurement process.

That is, the SNR can be varied in two ways. In one way, the transmitted signal may be reduced in view of its signal power while keeping thermal noise at the receiver constant. This may be a suitable way to measure the sensitivity under absence from interference sources. In a different way, the transmit power may be kept constant and the additive noise level injected by a noise generator may be increased. Alternatively or in addition, instead of the noise or in addition hereto, various kinds of interference signals not satisfying these statistical properties of Gaussian noise can be used. Those ways may be combined, e.g., keeping the sum of transmitted signal+noise constant or according to a targeted sum value. Whilst the second way and the combination may provide for a constant or steerable or controllable receive signal input level at the receiver side, therefore including impact from automatic gain control on the measurement uncertainty (MU), option 1 includes, e.g., quantization noise effects for low level of chosen SNR, when the effective analogue or digital resolution is reduced and therefore may introduce additional MU, in particular, when signals with high PAPR (peak-to-average power ratio) are used. Similar effects can be observed if very high signal input levels are to be used during the measurement, causing input saturation or clipping at the receiver including the associated signal distortion.

According to an embodiment, the quality measure may comprise an uncoded bit error rate. Method 2100 may be implemented such that the BER is statistically measured by changing the SNR for every channel realization. For example, one measurement method may produce and additive wide Gaussian noise (AWGN) curve for every channel realization and the statistical behaviour may be derived from the sufficient high number of channel realizations to be averaged over. Alternatively, for each chosen SNR value a sufficiently high number of channel realizations may be chosen and the BERs may be averaged. The sufficiently high number of channel realizations may be tested a priori by performing both test options and comparing the two to derive the MU. Choosing the lowest number for a selected MU allows to reduce test time for BER measurements. Furthermore, depending on the level of BER to be measured, the number of channel realizations can be adapted, e.g., at a high BER (e.g., 10⁻¹ or 10⁻²). A smaller number of channel realizations may be sufficient while a very low BER (of e.g., 10⁻⁵ or less) may be associated with more channel realizations to be provided. Alternatively or in addition, a certain SNR point may remain fixed and a sufficiently high enough number of channel realizations may sequentially be provided with a channel emulator of the TE. The sufficiently high number may depend on or at least be influenced by a quality of the desired result. The higher the number of channel realizations, the more reliable the result may be. However, to save measurement time, a lower number of e.g., 3, 4, 5, 10 or more may be used.

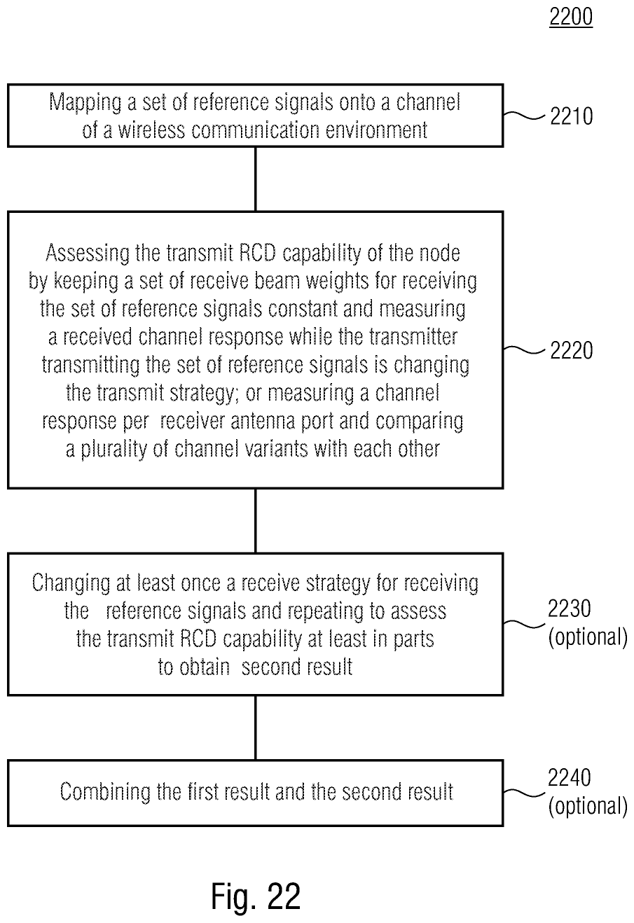

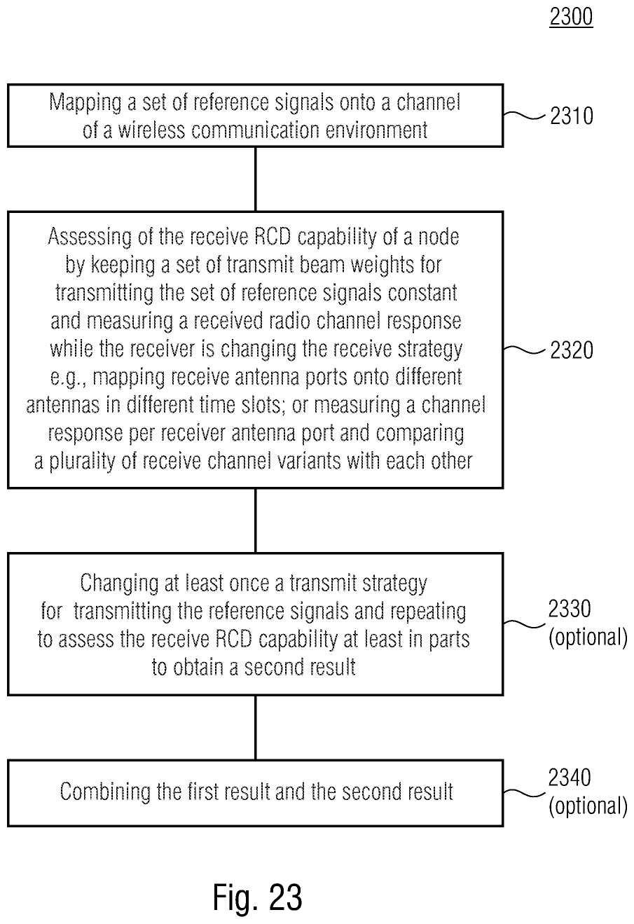

In connection with FIG. 22 showing a schematic flowchart of a method 2200 for determining a transmit RCD capability of a node and FIG. 23 showing a schematic flowchart of a method 2300 for determining a receive RCD capability of a node, it is shown that determining knowledge about a transmit RCD capability and a reception RCD capability may be obtained independently from each other but also in combination.

Both methods 2200 and 2300 may each be performed with additional optional steps so as to arrive at a method in which the transmit RCD capability and the receive RCD capability may be obtained. The respective results may be combined with each other.

With reference to method 2200, in 2210 a set of reference signals may be mapped onto a channel of a wireless communication environment.

In 2220, the transmit diversity capability of the node is assessed by keeping a set of receive beam weights, e.g., of a beam former such as the beam former 72 as illustrated in FIGS. 12 and/or 13, constant during receiving the set of reference signals. A received channel response may be measured while the transmitter that transmits the set of reference signals is changing the transmit strategy. Alternatively or in addition, a channel response per receiver antenna port may be measured and a plurality of channel variants may be compared with each other.

This may be referred to a first result of the method 2200. Optional step 2230 comprises changing at least once a receive strategy for receiving the reference signals and repeating to assess the transmit RCD capability at least in parts to obtain a second result. That is, step 2220 may be repeated with a different receive strategy. The first and the second result may be combined in an optional step 2240 to obtain both, the transmit RCD capability and the receive RCD capability.

Correspondingly, method 2300 comprises mapping a set of reference signals onto a channel of a wireless communication environment in 2310 which may correspond to 2210. In 2320 the receive RCD capability of the node is assessed by keeping a set of transmit beam weights used for transmitting the set of reference signals constant.

A received radio channel response while the receiver is changing the receive strategy, e.g., mapping receive antenna a points onto different antennas in different time slots. Alternatively or in addition, a channel response may be measured per receiver antenna port and a plurality of receive channel variants being measured may be compared with each other. That is, in 2220 and 2320, measurements may be made per antenna port or for the set of ports in the wireless interface arrangement.

Method 2300 may comprise the optional step of changing at least once a transmit strategy for transmitting the reference signals and repeating to assess the received diversity capability at least in parts to obtain a second result. In 2340, optionally, the first result and the second result may be combined. An output of 2240 and 2340 may be equal or at least comparable.

Changing the transmit strategy may relate to mapping the reference signals onto different antennas in different time slots or on different subcarriers or bandwidth parts (BWP). Using different antenna mappings for different carrier/bandwidth parts provides an alternative implementation to measure antenna RCD capability provided that the chosen difference/distance in frequency is beyond (uncorrelated) or within (correlated) the coherence bandwidths with respect to the effective radio channel.

The channel selected for the reference signals in 2210 and 2310 may be selected so as to use a suitable channel in the provided environment, e.g., a test environment or a real environment. Suitable in this context means that the mapping of the reference signals may be known to the receiver and/or that the channel has sufficient relative signal strength compared to the remaining channels mapped to the overall transmitted signal. As an example, making the measurement based on a signal component which is de facto buried in other signals, the other signal being, for example, a thousand times bigger, may have impact on the MU and may increase measurement time to reduce MU by more, additional measurements. Furthermore, some channels may more narrowband than others or spread out in time when looking at the resource allocation. Therefore, suitability may have a notation of choosing a channel which allows most effective and efficient measurement of the RCD capability as a result of the provided propagation environment, the DuT's antenna capabilities and distribution and the location, orientation of the DuT within the measurement environment or TE. Furthermore, for measuring, for example, BER, and in particular encoded BER, the received signals have to be known, therefore channels which provide many known bits per channel are considered very suitable for BER measurements in terms of measurement time reduction. This can be achieved by, e.g., resending a known sequence of test data instead of random data provided that the encoded data and/or the mapping of the data onto the radio resources is tested to fulfil sufficient randomness to avoid a bias on the MU.

As described for changing the transmit strategy, changing the receive strategy may comprise a mapping of receive antenna ports onto different antennas in different time slots or on different subcarriers or bandwidth parts.

A result of method 2200 and/or method 2300 may be used to perform communication in a wireless communication network by exchanging an obtained diversity capability information or by adapting control of a wireless interface based on the obtained diversity capability information. For example, the result or values derived thereof may be stored in a device and/or a database and may be assessable for one or more devices in a wireless communication network and/or environment.

Method 2200 and/or method 2300 may further comprise obtaining a plurality of results, each result indicating a quality of a combination for a transmit strategy and a receive strategy for transmitting and receiving a radio signal. As described, each of the results may relate to a specific combination of a transmit strategy and a receive strategy. The method may comprise sourcing the plurality of results according to a quality measure to obtain sorted results. Further, the method may comprise providing at least a part of the sorted results to a transmitter and/or receiver for further transmission and/or reception of a radio signal between the transmitter and the receiver. For example, such a plurality of results may be obtained in an in-field test during operation or the like.

That is, when using a certain combination of transmit diversity at the one node and receive diversity/strategy at the other node, the combinations may be numerous and possibly hard or almost impossible to ordered in terms of specific matrix, e.g., end-to-end RCD capability or end-to-end RCD capability variants. Therefore, in particular, when the RCD capability is chosen or optimized in-field, the transmit-receive RCD capability combinations may be ordered according to a chosen metric as input for a selection or decision algorithm.

That is, embodiments relate to calculating a good/best combination of transmit/receive strategy instances with at least one instance, the instances selected so as to provide/fulfil a certain transmit/receive/link RCD capability. Feedback may be provided to the other end of the link for assisting the transmit/link diversity strategy. A selection combination of spatial transmit/link diversity instances may be applied at the transmitter and/or receiver into a specific link direction. The same can be done into the opposite link direction as an alternative or in addition.

In other words, aspects relate to one more of the following.

### Test Procedure for Radio Channel Diversity Capability Assessment

The radio channel diversity (RCD) capability in a radio link between two nodes can be assessed/measured in a test environment using the following setup:
Bring the device under test (DuT) inside a test environment e.g., measurement chamber.
Connect the device with a test equipment (TE) e.g., emulating a base station or a UE.
Provide the device with a radio propagation environment which can be repeatedly changed e.g., fading simulator allowing emulate multipath effects and varying coupling of spatial modes (this corresponds to e.g., an increasing scalar product (1 means full correlation; 0 means full decorrelation) of normalized columns or normalized rows of the channel matrix)
   Expose the DuT over the air (OTA) e.g., with a multi-probe/multi-sensor setup surrounding the DuT to provide a virtual propagation environment.
Establish a connection between the DuT and the TE suitable to operate in measurement or test mode.
Select a particular physical channel to be loaded with a continuous data flow (can be different content or repeatedly the same content) and (semi-persistent) resource allocation and fixed MCS level. If possible, use coding for forward error correction or high code rate with little coding gain.
Initiate transmission into the first direction (DuT to TE) and a second direction (TE to DuT) with fixed setting of scheduling, physical channel loading and MCS selection:
   Repeatedly provide the same sequence of radio channel realizations for the first direction and/or the second direction.
   Measure uncoded Bit error rate (BER) curves over a repeated sequence of radio channel realizations at various signal to noise ratio (SNR) points.
   SNR can be varied in 2 common ways:
      Option A (SNR controlled by noise generator)→excludes the gain control of the receiver and therefore test more the digital signal processing of the receiver.
      Option B (SNR controlled by transmit signal variation)→includes the automatic gain control of the receiver, receiver quantization etc. and allows detection of sensitivity.
   BER can be measured statistically by either changing the SNR for every channel realization or for keeping a certain SNR point fixed and sequentially providing a sufficiently high enough number of channel realizations with the channel emulator (a statistically sufficient high number of channel realizations can be calculated by statistical means based of the provided realizations/instances of the synthesized propagation channel (channel model).
   When introducing different channel correlation to test the throughput and/or BER performance of the device in the wireless link in transmit and/or receive mode, the correlation can be put into the channel model used by the emulator as e.g., transmit or receive side covariance matrix describing the correlation between antennas/antenna ports at the transmitter and the receiver, respectively.
   Derive radio link diversity gain (metric) e.g., from the slope in the BER plotted vs. SNR (refer to one of the figures with uncoded BERs).

### In-Field Testing of RCD Capability

When a device of a certain radio channel diversity (RCD) capability is deployed in the field, its effective RCD capability is a function of the propagation environment, the orientation of the device, the spatial scheme supported by the communication partner, the radiation patterns used (and their polarization) etc.

For optimum exploitation of the provided RCD capability under one specific or a sequence of channel realization(s) (this is in contrast to the testing under know statistical properties of the channel) the effective RCD capability can be assessed/determined in a closed-loop fashion.

In the following the inventors describe one option to assess the effective RCD capability without excluding other options.

The first node/device and the second node/device communicating with each other over a bi-directional wireless link can assess the RCD capability by doing the following:
Map reference signals onto a particular channel suitable for channel measurements
A: For assessment of transmit RCD capability:
   Keep receive beam weights constant and measure received channel response while the transmitter is changing the transmit strategy e.g., mapping RS onto different antennas in different time slots. Alternatively, measure channel response (channel coefficients) per receiver antenna port. Compare the various transmit channel variants using e.g., normalized or un-normalized scalar products between all transmit access instances.
B: For assessment of receive RCD capability:
   Keep transmit beam weights constant and measure received channel response while the receiver is changing the receive strategy e.g., mapping receive antenna ports onto different antennas in different time slots. Alternatively, measure channel response (channel coefficients) per receiver antenna port. Compare the various receive channel variants using e.g., normalized or un-normalized scalar products between all receiver access instances.
C: For assessment of combined transmit RCD capability and receive RCD capability:
   Combining a selection or all sequences of transmit options and a selection or all sequences of receive options and cross correlate the channels instances (channel vectors/matrices)
Calculate good/best combination of transmit/receive strategy instances which provide/fulfil a certain transmit/receive/link RCD capability.
Provide feedback to the other end of the link for assisting the transmit/link diversity strategy.
Apply a selected combination of spatial transmit/link diversity instances at the transmitter and/or receiver into a specific link direction. (the same can be done into the opposite link direction).

### RCD Capability Signalling

A communication link is established between a pair of devices wherein each device is equipped with the means to signal its RCD capability to the other device.

The transfer of the RCD capability information from the first device to the second device is provided at least once: during an initial negotiation between devices; before the RRC state is established; after the RRC is established; during the call/connection; repeatedly; at fixed intervals; upon request; upon a triggering; as a result of a threshold condition; as a result of a change of operation; as a result of a change of conditions.

The transfer of the RCD capability information from the first device to the second device is signalled using at least one of: a logical channel such as a common control channel (CCCH) or a dedicated control channel (DCCH); a transport channel such as a downlink shared channel (DL-SCH) or an uplink shared channel (UL-SCH); or a physical layer data channel such as a physical downlink shared channel (PDSCH), a physical downlink control channel (PDCCH), a physical uplink shared channel (PUSCH) or a physical uplink control channel (PUCCH). The use of these channels provides a method for organising the data flow over the radio interface of the communications network. Using channels enables the communications system to recognise the type of data that is being sent and to deal with it accordingly. In addition to the established and aforementioned channels, the RCD capability signalling could be performed over a new radio control channel (NRCC).

### Exploiting RCD Capabilities

A communication link is established between a pair of devices wherein each device is equipped with the means to signal RCD capability to the other device.

RCD capability information is provided by at least a first device or a second device.

RCD capability information provided by a first device is used by at least the first device or the second device.

RCD capability information exchanged between a first device and a second device is used by at least the first device or the second device.

The RCD capability information of the first device and the capability information of the second device is processed by the first device so that it can decide, based on one or more criteria, how the first and second devices should be configured.

Examples of the criteria are not limited to include: capacity; reliability; throughput; spectral efficiency; power efficiency; user density; antenna pattern; beam direction; interference reduction; and so on.

Examples of the way in which the devices could be configured are not limited to include: number of antenna ports for reception; number of antenna ports for transmission; number of physical antennas for reception; number of physical antennas for transmission; number of antenna beams for reception; number of antenna beams for transmission; direction of transmission beam(s); direction of reception beam(s); selection of transmission scheme (diversity, multi-stream); selection of reception scheme (diversity, multi-stream); selection of frequency; selection of panel(s); selection of modulation and coding scheme.

For decision making purposes, paired devices could be arranged as master/slave for example the basestation/user equipment, respectively. Alternatively, when relay devices are used, the determination of the master authority could be inherited.

### Unidirectional and Bidirectional RCD Equivalence/Correspondence

Considering that a device is able to communicate with another device in two directions (bidirectional) two observations/measurements and associated capability signalling are or interest for unidirectional and/or bidirectional link optimization of the effective radio channel exploited for radio communication between the two devices.

This aspect of RCD capability can be called diversity correspondence and has the following meanings:
a. The receive RCD capability achievable by the device, configured for a particular diversity scheme using available antennas at the device is to be compared with the transmit RCD capability achievable by the device assuming the same wireless propagation environment and associated appropriate/suitable (weak formulation) reciprocal (strong formulation) reception/transmission behaviour at the other device. In other words, the overall signal processing including antenna selection/beamforming/transceiver configuration etc. allows a quasi-reciprocal contribution/behaviour with regard to the achievable RCD capability when receiving a signal from and when transmitting signals to the communication partner (the other device/node). This single side diversity RX/TX correspondence behaviour/capability characterizes a special capability of the device to be exploited in collaboration with another device.
b. The achievable first RCD capability of a radio link between a first device transmitting and a second device receiving and the achievable second RCD capability of a radio link between a second device transmitting and a first device receiving are the same or similar within some predefined margin. This link direction RCD capability equivalence is in particular valuable if iterative algorithms are used/exploited for mutual link optimization exploiting reciprocal radio channel properties of similar link RCD capabilities in both wireless link directions.

The RCD capability can be used to describe a diversity degree or a gain a device can contribute for unidirectional or bidirectional communication link between two communication nodes. As long as the radio channel between the two nodes remains (quasi-)constant and fulfils stationarity conditions such RCD capability indication can be used e.g., for link optimization and scheduling decisions in the near future.

The same argument is valid for the signal maintenance capability indicating the number of data streams which can be transmitted in parallel via a MIMO scheme.

Embodiments have been described in connection with RCM and RCD, both concepts making use of antenna elements, in particular additional antenna elements used for maintaining additional data streams for diversity respectively. Embodiments further relate to another concept that may be exploited with additional antennas, interference suppression. By use of additional antennas a crosslink interference may be reduced or at least partially suppressed. That is, a device may use an antenna that is additional with regard to an antenna used for the first link or the like, for interference suppression, RCD or RCM.

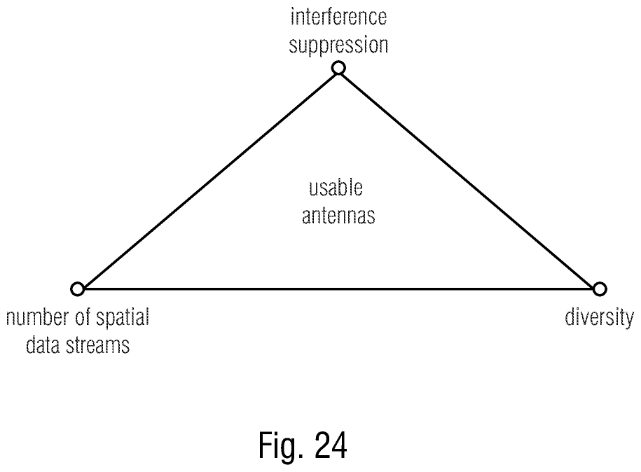

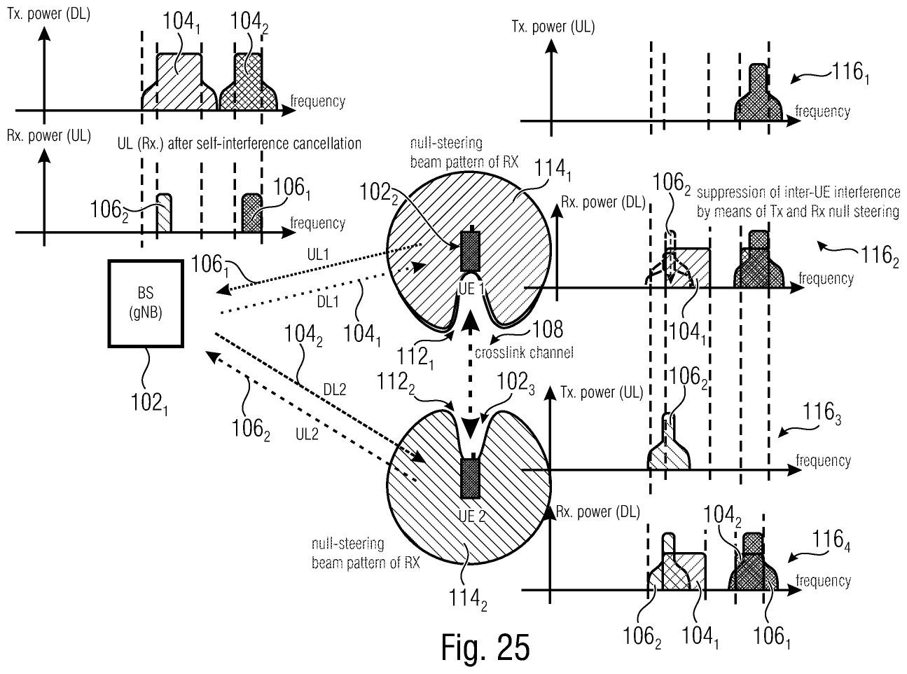

FIG. 24 shows a schematic illustration of a relationship between the concepts of interference suppression, a number of spatial data streams, e.g., in connection with radio channel multiplexing, RCM, and the use of diversity. This triangle illustrates a decision space of a device in accordance with embodiments, the decision space allowing to use an additional antenna element for one of the mentioned purposes and a set of additional elements for a single purpose or a mixture of two or three purposes of interference cancellation, RCM and RCD. In one embodiment, the RCM in connection with interference suppression may result in a remaining RCD capability that provides for an additional robustness against unexpected interference. Such a device or node may perform its communication using its RCM capability and perform interference suppression as, e.g., described in connection with FIG. 25 and may react on unexpected interference with its RCD capability. An order or sequence of RCM, RCD and/or interference cancellation may differ in embodiments, and/or may differ from time to time or from link to link, e.g., when comparing ultra-reliable low latency communication, URLLC, with a video stream which may have different requirements in view of data throughput or latency, thereby resulting in different strategies on how to use the available antennas.

For example, a use of antennas may be decided at a device or for a device by considering a correlation of antennas, signals transmitted or received thereby respectively. More uncorrelated receive signals at different antennas that are based on a same radio signal may provide for an indication to use those uncorrelated antennas for RCD whilst more correlated antennas may be used more likely for RCM or interference suppression. Such a correlation may be determined, e.g., using a scalar product of vectors representing a signal received with different antennas.

For example, in case of other pairs of communicating device/nodes within the vicinity/link range of a first pair of communicating nodes/devices co-channel interference can have impact on the effectively remaining RCD for the active links of the first communication pair. In other words, the receiver with a certain RCD capability with respect to the incoming communication link may be used or even needed to use some of its receive antenna degrees to detect and separate interference signals from other communication pairs during receive signal detection, therefore effectively reducing the available RCD capability for the “desired” radio link.

Since the spatial interference pattern may be dynamic in time and spectrum, the RCD capability may have to be signalled in suitable validity compartments in time and frequency e.g., indicating specific subcarriers, resource blocks, bandwidthparts (BWP), frequency bands and time slots, sub-slots, OFDM symbols.

Furthermore, since interference is often not easy to predict by the individual nodes, the observed interference patterns can be monitored over a larger observation window, allowing certain predictions for future interference patterns and/or analysing the patterns for interference sources and provide suitable information enabling coordination of several links active in parallel. Such information may include e.g., interference source location, direction, the ID of the interferer etc. The interference mitigation/avoidance strategy may include actions of the other communication links reconfiguring their transmit strategy and/or sharing intended co-channel use in time, frequency and/or spatial configuration.

In half-duplex FDD and TDD systems this kind of co-channel interference usually happens in the downlink as inter-cell interference, when users experience similar pathloss from two base stations. In the multi-user uplink to a base station, uplinks from users close to the cell border may supper interference from users connected to the neighbouring base station and being scheduled at the same radio resources.

When considering Full Duplex Radio schemes, which means that a node/device can transmit and receive at the same time, so-called cross link interference (CLI) between nodes close by to each other and the one node receiving signals from its communication partner, while the other is transmitting to its own partner. This may apply to inter UE CLI and inter-BS CLI, mostly depending on the radio channel between the transmitter (aggressor) and the receiver (victim). Again, when the remaining RCD capability on a particular link is sufficiently high, certain degrees of the RCD can be used to suppress the CLI.

The CLI effect may be somehow different and therefore subject to higher dynamics since e.g., UEs can be positioned closely to each other on a desk or in a car while connected to the same base station.

Therefore, as described in the co-channel interference case monitoring of the interference patterns and their associated radio channel and radio channel statistics is beneficial to e.g.:
Determine interference sources, their location, relative location distance, transmit activity patterns, effective impact on the “desired” link etc.

Furthermore, such collected information obtained from observations/measurements can be forwarded in processed or unprocessed format to entities being in charge of configuring the “desired” active communication link between the victim's communication partner and the victim and between the aggressor and its own communication partner. For the desired link this will usually the serving first base station of a UE, while for the aggressor it will be its own serving second base station, where in a Full Duplex scenario the first and the second serving base stations may be one and the same.

FIG. 25 shows a schematic block diagram of a wireless communication scenario comprising a base station 102₁ and UEs 102₂ and 102₃, wherein each node 102₁ to 102 may be implemented in accordance with embodiments described herein, i.e., may perform RCM management and/or RCD management and may be implemented as UE, base station, relay or any other node, as described.

For example, base station 102₁ provides for downlink, DL, signals 104₁ to node 102₂ and 104₂ to node 102₃. As the other nodes the base station 102₁ may be configured for a full duplex communication such that it may, at a same time, receive an uplink signal 106₁ from node 102₂ and an uplink signal 106₂ from node 102₃. However, based on a spatial neighbourhood of nodes 102₂ and 102₃, the downlink signals 104₁ and 104₂ and/or the uplink signals 106₁ and 106₂ may provide a source for interference, a crosslink interference, CLI, of a crosslink channel 108. To avoid or reduce effects of the interference, as an alternative to RCM and RCD, the node 102₂ and 102₃ may perform interference suppression by directing, for example, a null 112₁ and/or 112₂ of a beam pattern 114₁, 114₂ respectively towards the other, interfering node 102₃, 102₂ respectively. For example, the node 102₂ ay steer a null of an receive, RX, beam pattern used for receiving signal 104₁ and/or node 102₃ directs a null of a transmit, TX, beam pattern used for transmitting signal 106₂ towards the respective other UE. That is, node 102₂ may perform a null-steering of an RX pattern whilst, as an alternative or in addition, node 102₃ performs null-steering of a TX pattern or vice versa. This does not exclude to also or as an alternative steer nulls of the respective other beam pattern used for signals 106₁ and/or 104₂ such that any combinations of RX/RX, TX/RX, RX/TX and TX/TX patterns may be adapted.

Such a behaviour may allow for interference suppression shown in plots 116₁ to 116₄ sowing schematic example representations of transmitted (TX plots 116₁ and 116₃) and received (RX plots 116₂ and 116₄) powers. RX powers and TX powers may comprise an overlap in the frequency domain which may cause interference which may be reduced by null steering as indicated in plot 116₂ sowing a reduction in received power from signal 106₂ at node 102₂ based on the interference suppression.

Plots 118₁ and 118₂ show a received and a transmitted power at the node 102₁ which may correspond, at least in parts and under consideration of the radio propagation channel with the signals 106₁, 106₂ and 104₁ and 104₂.

In other words, FIG. 25 shows an example of Full Duplex Communication in a cellular setup, where the BS(gNB) 102₁ is transmitting signals to UE1 and UE2 while UE1 and UE2 are transmitting to the BS in the same time slot. Due to their proximity, UE1 and UE2 cause cross link interference, CLI, to the receivers configured to receive and detect the signals from the BS. As depicted in the figure, UE1 and UE2 can use the capability of their multiple antennas to separate the CLI from the intended (“desired”) data stream from the BS. By using some of the spatial degrees for interference separation/suppression, the signal maintenance (spatial multiplexing) capability and the RCD capability for the “desired” link of interest is reduced/affected. Ideally this should be reported in a timely manner and be associated with the patterns of the relevant and active interference sources. Alternatively, a conservative approach could expect a worse case corresponding to a certain time window observed/monitored before configuring the active link.

Embodiments further relate to determining and providing or reporting the capability to handle interference which is referred to as herein as Radio Interference Management, RIM, capability. Making reference again to FIG. 24, a specific point or line within the triangle that is determined by selecting a specific RCM and RCD behaviour, thus resulting in an amount of interference, i.e., a number of interferers or the like, e.g., associated to one or more multipath components, that may be handled with remaining usable antennas in uplink and/or downlink. That is, the RIM capability may, amongst other things, indicate a number of spatially distinguishable sources of interference suppressable by the device. With or without having already set a specific mode of operation for RCM and/or RCD, an apparatus or device in accordance with embodiments may report or indicate its capability to handle interference by suppression, i.e., its RIM capability, e.g., as a specific value indicating a number of antennas, or a number representing the spatial degrees of freedom, a value indicating a remaining gain to be achieved when transmitting and/or receiving a signal and using the capability, such as “additional 10 dBm” or the like.

That is, independently from informing other nodes about the signal maintenance capability or RCM capability and/or independently from the indicating the RCD capability, an apparatus in accordance with embodiments may be configured to indicate to its communication partner ort a different entity within the network its absolute, e.g., based on its hardware and/or software configuration, and/or relative or temporal RIM capability, e.g., the absolute capability in connection with a present usage of the device, the implemented RCD and/or RCM.

As may be seen from FIG. 24 and FIG. 25, an occurrence of interference may lead to an scenario in which the apparatus is uncapable of suppressing the interference sufficiently whilst maintaining the RCD and RCM setting, e.g., as the number of available antennas exceeds the implementation of RCM, RCD and RIM, i.e., a point outside the triangle of FIG. 24 would be obtained. This may be prevented if the apparatus decides to not or only in parts suppress the interference. In a case where suppression beyond the present capability is to be implemented, an apparatus according to an embodiment may be configured for changing the RCM setting and/or the RCD setting responsive to the experienced interference. Changing the RCM setting may relate to changing, in particular reducing, a number of spatial paths to be used for the data streams and/or to use different paths or multipath components, in particular at least one multipath component that involves less RCD capability and/or less interference suppression. As an alternative or in addition, changing the RCD setting may relate to choose/select different antennas or antenna ports for diversity and/or to reduce a number of antennas used for diversity which may in turn release antennas for interference suppression. In other words, experiencing interference may affect the RCD and the RCM setting independently or together at the receiver and/or the transmitter respectively. That is a transmit and/or receive strategy may be changed.

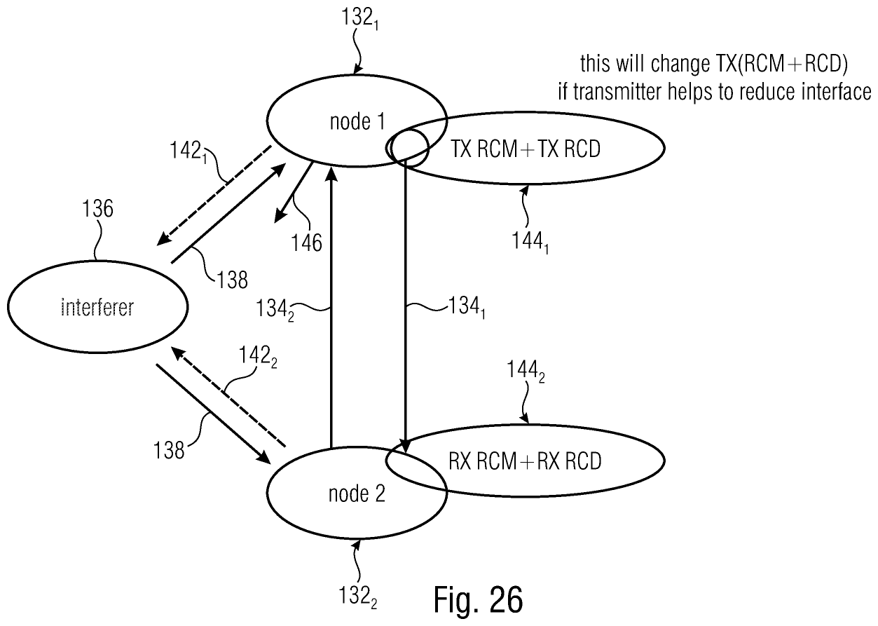

Such a scenario is illustrated in FIG. 26 in which a schematic block diagram of a wireless network environment is shown that may form at least a part of a wireless network in accordance with embodiments. Nodes or apparatus 132₁ and 132₂ may communicate with each other unidirectional from apparatus 132₁ to node 132₂ or vice versa or bidirectional, e.g., in half duplex or full duplex. For example, by using a wireless interface of the respective apparatus such as wireless interface arrangement 12 of other apparatus, a signal 134₁ may be transmitted from apparatus 132₁ to 132₂ and a signal 134₂ may be transmitted in the other direction. An interferer 136 may cause interference 138 for apparatus 132₁ and/or 132₂, e.g., similarly as described in connection with FIG. 25. Optionally, interference 138 may at least in parts be caused by a communication of apparatus 132₁ and/or 132₂ by communication with the interferer 136, e.g., comprising a transmission of signals 1421 and/or 142₂. A setting 144₁ of apparatus 132₁ including a TX RCM and a TX RCD setting may be changed by apparatus 132₁ responsive to interference 138. Alternatively or in addition an RX RCM setting and/or an RX RCD setting may be changed. Alternatively or in addition, apparatus 132₂ may change its RX RCM setting and/or RX RCD setting as shown for setting 144₂ and/or may change a corresponding TX setting.

In other words, a TX (RCM and RCD) setting may be changed when apparatus 132i decides to perform interference suppression and/or, an RX (RCM and RCD) setting may be changed when apparatus 132₂ decides to perform interference suppression. Informing other nodes about the RIM capability, e.g., by wirelessly transmitting a signal 146 indicating the absolute or temporal RIM capability, other nodes may consider to adapt their transmit and/or receive strategy, e.g., so as to allow finding a solution, by decentralised nodes and/or a centralised entity that allows a high overall throughput and/or communication quality. The signal 146 may be referred to as an interference capability signal. Embodiments relate to exploit, at the receiving node, the RIM information by adapting an own transmission and/or by requesting the other apparatus 132₁ to select a specific RCD and/or RCM setting to allow for a robust communication, wherein apparatus 132₁ ma operate according to the request, at least within its capability or present offer as described. Signal 146 may indicate an interference suppression information indicating a capability of the apparatus to handle or suppress interference

The full duplex operation case and the half duplex case may need reporting, exchange of the supported/provided RCD and signal maintenance capability in shorter time intervals when compared to known concepts as the orientation of the three devices relative to each other and/or available multipath components, MPC, used by the devices or the like may rapidly change. Alternatively or in addition, the supported/provided RCD and signal maintenance capability may be indicated in a descriptive way indicating which time-frequency resources and/or patterns are effected/associated with a different RCD and/or signal maintenance capability.

Such changes can be signalled in various ways, including e.g.:
Max-min RCD and associated pattern
Minimum RCD to be used
Changing trade-off between RCD and signal maintenance between instances of channel use
Etc. to be extended

This results in a parameter which may be referred to as an effective RCD and/or effective RCM capability as those capabilities are based, influenced or dependent on the used MPC and also influence each other, see FIG. 24. A device may report its observation window, i.e., it may indicate a time or time duration during which the measurements to determine a RCM or RCD capability where taken. Further, the RCM and/or RCD capability may be updated for a device as it depends on the actual scenario. For example, in a repeated manner, the device may report its rank indicator (RI) and/or possible modulation coding schemes, MCS, per data stream. Alternatively or in addition it may report its RCD capability, e.g., a number of antennas available or other associated data.

The described in-field test may be performed repeatedly, e.g., as a part of a link adaptation procedure and/or a test procedure. For example, the RCM and/or RCD capabilities may be tested or determined when determining Channel Quality Indicators (CQI) and/or a rank indicator, RI. According to an embodiment, an may be configured for repeatedly determining the RCD capability, the RCM capability and/or a measure for a level of interference to be suppressed to obtain a determination result; and for reporting the determination result. This may allow a communication partner or other nodes to exploit the capabilities of the node.

RCD and/or RCM capabilities may be determined from measurements made in a test environment or from measurements made in-field. Although it is not necessary to determine the RCD and RCM capabilities of a device in-field it is an advantageous concept as those capability may vary with the radio propagation channel. It is expected that these two measurement environments or measurement conditions will yield measurement results that are generally different or in other words, are seldomly similar, due to the differences associated with the two environments and the way in which the device is used in those environments. A combination or processing of the two sets of results might therefore provide information about the environment and/or the way in which the device is being used. That is, starting from a result in a test environment with known conditions, a deviating result may indicate a change in the conditions, e.g., the radio propagation channel. In addition, the two sets of information might also be processed so as to determine properties of the radio channel and hence the propagation channel that was present at the time when the measurements were made in-field.

The following paragraph describes examples of changes in the effective radio channel and how the transmit/receive strategy can be adapted to compensate for such changes in terms of maintained robustness/resilience against changes in the effective radio channel.

Let's assume a propagation environment and the use of transmit and receive antennas/antenna ports/beams by the communicating devices creating an effective radio channel available for communication and data transmission from a transmitting device to a receiving device.

The spatial degrees of freedom exploitable for data stream multiplexing and signal diversity are determined by the number of transmit antennas, the number of receive antennas and how these antennas are used to feed into and receive from the propagation environment, including the number of relevant multi-path components (MPC) contribution effectively to a kind of multipath propagation environment. In other words, the upper bound of the addressable spatial degrees of freedom is defined by the effective number of distinguishable MPCs between the transmitter and the receiver. Usually and in particular in FR1 (below 6 GHz) the number of MPC is large compared to the degrees of freedom provided by a MIMO antenna arrangements. In contrast to this in FR2 (10 GHz and above) antenna arrays are commonly used to create beamformed antenna radiation patterns with s a high antenna gain (narrow beamwidth) by using large number of antenna elements per antenna array. For example, in long distance scenarios between the communicating nodes the Rician factor increases (ratio of signal power in Line of Sight (LOS) and signal power in NLOS) and hence beamforming on the LOS component as the dominant MPC is advised in order to maximize the transferred signal energy from the transmitter to the receiver. When reducing the signal path to one LOS the spatial degrees usually shrink to 2 polarization components while the LOS link becomes vulnerable against blockage, e.g. objects passing through the LOS which is quite likely in non-stationary scenarios. If such blockage events happen, the single and strong MPC disappears within Milliseconds and a link failure may be the result. Alternatively, e.g., 50% of the signal energy could be transferred via additional MPCs, reducing the energy transferred via the LOS by 3 dB, while the other 3 dB of transferred energy pass through other MPC usually experiencing a higher attenuation. In return using additional MPCs per data stream provides macroscopic spatial diversity against blockage and therefore resilience for a point to point link.

This means that a proactive transmit-receive strategy between two node operating in FR2 would include the inclusion of a sufficient number of multipath components when selecting the beamwidth of the main-lobe and/or a more sophisticated antenna radiation pattern.

In case of incoming interference to the receiver antenna array, the antenna radiation pattern can be formed such that spatial nulls are created into the directions of the MPCs relevant for the aggressor (interference) channel between the interference source and the victim receiver. Such sophisticated receive beamforming to suppress passing through an larger number of MPCs will reduce the remaining degrees of freedom for receive signal optimization of the “desired” signal significantly, therefore affecting the remaining RCD and RCM for the “desired” link.

Overall, it can be stated that the available spatial degrees of freedom of the effective radio channel are dependent on the number of effective MPCs, number of transmit antennas/transmit antenna ports/transmit beams, the number of receive antennas/receive antenna ports/receive beams and the applied transmission and reception strategy and furthermore the number of interference sources (aggressor), their distance and relative position/orientation to the receiver (victim), their associated effective interference channel including the interference MPCs etc. All these parameters are spanning a large vector of input signals (“desired” data signals+interference signals) going over an effective radio channel (channel matrix between “desired” transmitter and receiver and channel matrix between all interference sources and receiver) and the receive vector at the device intended as recipient of the “desired” message and victim of “unwanted” interference at the same time.

The entanglement of the data channel and interference channel can be handled by appropriately trading the available RCD at the receiver to combat interference against remaining RCD and RCM on the “desired” link. Since interference situations can dynamically change the adaptation of spatial receiver signal processing has to be adapted at the same speed/rate and the changing remaining RCD and RCM status has to be reporting/exchanged/negotiated between the receiver and its belonging transmitter to keep the ongoing and future transmission cycles/bursts well matched to the channel capacity.

All of the before mentioned signal sources are interrelated/interconnected and can be traded against each other using appropriate spatial signal processing.

Nevertheless the remaining RCD is a kind of measure or resilience or robustness against changes in the radio channels (intended and aggressor) and changes in the load of the links (intended and aggressor).

In brief: the more antennas are available at a device/node the more degrees of freedom the overall transmission scheme will have provided to be used for interference suppression/reduction and/or optimization of the “desired” communication link.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus configured for wirelessly communicating in a wireless communication network, the apparatus comprising:
a wireless interface arrangement for the wireless communication;
wherein the apparatus is configured for wirelessly transmitting, to a receiving apparatus, a diversity signal comprising a diversity information indicating a radio channel diversity (RCD) capability of the apparatus; the RCD capability relating to a capability of the apparatus to perform diversity for the wireless communication.

2. The apparatus of claim 1, wherein the apparatus is configured for transmitting RCD capability information so as indicate, as a binary signal comprised by the diversity signal, whether or not the apparatus is configured for using a reception diversity for the wireless communication.

3. The apparatus of claim 1, wherein the apparatus is configured for transmitting the RCD capability information so as indicate whether or not the apparatus is configured for using a transmission diversity for the wireless communication.

4. The apparatus of claim 1, wherein the apparatus is configured for transmitting the RCD capability information so as to indicate a degree of diversity supported by the apparatus.

5. The apparatus of claim 1, wherein the apparatus is configured for transmitting the RCD capability information so as to indicate an RCD scheme supported by the apparatus.

6. The apparatus of claim 1, wherein the apparatus is configured for transmitting the RCD capability information so as to indicate a plurality of RCD schemes supported by the apparatus.

7. The apparatus of claim 6, wherein the apparatus is configured for applying a selected RCD scheme for further wireless communication responsive to a reception of a selection signal indicating the selected RCD scheme from the plurality of RCD schemes.

8. The apparatus of claim 1, wherein the apparatus is configured for receiving, from a requesting apparatus, a request signal indicating a request to perform a specific RCD scheme and for perform negotiation with the requesting apparatus about the specific RCD scheme to identify a negotiated RCD scheme; wherein the apparatus is configured for applying the negotiated RCD scheme.

9. The apparatus of 8, wherein the wherein the apparatus is configured for transmitting a message to the requesting apparatus, the message indicating the negotiated RCD scheme, wherein the apparatus is configured for delaying transmission of the message until the offer is outdated due to real-time constraints.

10. The apparatus of claim 1, being a user equipment wherein the apparatus is a first apparatus, wherein the apparatus is configured for applying a specific RCD scheme for a transmission or a reception of a signal, wherein the apparatus is configured for receiving feedback information from a second apparatus being a base station, the feedback information indicating an effective quality of the specific RCD scheme, wherein the first apparatus is configured for maintaining, optimizing or changing the specific RCD scheme in a further transmission from the first apparatus to the second apparatus responsive to the feedback information signal.

11. The apparatus of claim 1, wherein the apparatus is a first apparatus and is configured for determining a feedback information indicating an effective quality of a specific RCD scheme usable for transmission from a second apparatus to the first apparatus, wherein the first apparatus is configured for transmitting the feedback information to the second apparatus.

12. The apparatus of claim 1, wherein the apparatus is a first apparatus configured for transmitting a request to a second apparatus to apply a specific RCD scheme.

13. The apparatus of claim 12, wherein the apparatus is configured for selecting the specific RCD scheme from a plurality of RCD schemes based on
observations of the first apparatus; and/or
knowledge about an RCD capability of the second apparatus.

14. The apparatus of claim 1, wherein the apparatus is configured for wirelessly transmitting, to a receiving apparatus, a capability signal comprising a capability information indicating a radio channel multiplexing (RCM) capability of the apparatus; the RCM capability relating to a capability of the apparatus to separate at least one spatial data stream during the wireless communication.

15. The apparatus of claim 14, wherein the apparatus is configured for separating at least two data streams based on the RCM capability.

16. The apparatus of claim 14, wherein the apparatus is configured for generating the capability signal such that the capability information indicates a maximum number of spatial data streams being utilizable simultaneously with the wireless interface arrangement.

17. An apparatus configured for wirelessly communicating in a wireless communication network, the apparatus comprising:
a wireless interface arrangement for the wireless communication;
wherein the apparatus is configured for acquiring an RCD information indicating an RCD capability of a communication partner; the RCD capability relating to a capability of the communication partner to perform diversity for the wireless communication;
wherein the apparatus is configured for adapting a control of the wireless interface arrangement for a communication with the communication partner based on the RCD capability; and/or to request the communication partner to adapt its wireless communication scheme based on the RCD capability of the first apparatus or on the RCD capability of the second apparatus or on the RCD capability of the first and the second apparatus.

18. The apparatus of claim 17, wherein the apparatus is configured for performing a test procedure with the communication partner during which a diversity scheme of the apparatus and/or of the communication partner is changed at least one time.

19. The apparatus of claim 17, wherein the apparatus is configured for receiving the diversity signal indicating a plurality of diversity schemes supported by the communication partner; and to select one of the indicated diversity schemes as a selected diversity scheme; and to transmit a selection signal to the communication partner indicating the selected diversity scheme.

20. An apparatus configured for wirelessly communicating in a wireless communication network, the apparatus comprising:
a wireless interface arrangement for the wireless communication;
wherein the apparatus is configured for wirelessly transmitting, to a receiving apparatus, an interference capability signal comprising a signal interference suppression information indicating a radio interference management, RIM, capability of the apparatus; the RIM capability relating to a capability of the apparatus to suppress interference;
wherein the RIM capability indicates a number of spatially distinguishable sources of interference suppressable by the device; or a specific value indicating a number of antennas, or a number representing spatial degrees of freedom, a value indicating a remaining gain to be achieved when transmitting and/or receiving a signal and using the capability.
